(19) United States
(12) Patent Application Publication
(10) Pub. No.: US 2024/0184969 A1
(43) Pub. Date: Jun. 6, 2024

(54) METHOD AND A PROTOTYPE ELECTRONIC CIRCUIT FOR DESIGNING AN ELECTRONIC CIRCUIT

(71) Applicant: Skyworks Solutions, Inc., Irvine, CA (US)

(72) Inventor: Mackenzie Brian Cook, Kanata (CA)

(21) Appl. No.: 18/527,145

(22) Filed: Dec. 1, 2023

Related U.S. Application Data
(60) Provisional application No. 63/429,748, filed on Dec. 2, 2022.
(60) Provisional application No. 63/429,876, filed on Dec. 2, 2022.
(60) Provisional application No. 63/429,931, filed on Dec. 2, 2022.

(51) Int. Cl. G06F 30/373; G06F 30/392; H03F 3/24

(52) U.S. Cl. CPC G06F 30/373; G06F 30/392; H03F 3/245; G06F 2115/08

(57) ABSTRACT

A method for designing an electronic circuit includes providing a prototype electronic circuit comprising one or more capacitors and one or more other components, at least one of the one or more capacitors being a variable capacitor; testing the electronic circuit by adjusting the capacitance of the one or more variable capacitors to determine one or more first capacitance values of the one or more variable capacitors that cause the electronic circuit to have one or more operating parameters that meet one or more desired operating parameters of the electronic circuit; determining, based on the testing of the electronic circuit, capacitance values for one or more fixed-value capacitors to replace the one or more variable capacitors in the electronic circuit, each of the fixed-value capacitors having a second capacitance value equivalent to the first value of the corresponding variable capacitor. A method of designing such a prototype electronic circuit is also provided. An electronic circuit designed by using the method, a radio frequency module comprising such an electronic circuit, a wireless device comprising such an electronic circuit are also provided.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure generally relates to electronic circuits and methods for designing electronic circuits, and particularly to amplifier circuits and methods for designing amplifier circuits.

### Description of Related Art

Recent advances in various computer-aided design (CAD), simulation, and modeling tools have enabled prediction of various parameters of complex electronic circuits with reasonable accuracy based on factors such as circuit configuration, dimensions and values of the components, and distance between the components.

Similarly, such tools may also be used to predict, with reasonable accuracy, values of circuit components that are likely to lead to one or more desired circuit parameters. For example, such tools may be used to predict input and output impedances by accounting for the impedance sources. This can be particularly useful for amplifier circuits given that amplification of electronic signal typically requires several stages of amplification as gain produced by a single amplifier is often insufficient. Such multi-stage amplification involves feeding an output of one amplifier into an input of another amplifier, for which impedance matching of inputs and outputs is necessary.

### SUMMARY

In some aspects, the techniques described herein relate to a method for designing an electronic circuit the method including: providing a prototype electronic circuit including one or more capacitors and one or more other components, at least one of the one or more capacitors being a variable capacitor; testing the electronic circuit by adjusting the capacitance of the one or more variable capacitors to determine one or more first capacitance values of the one or more variable capacitors that cause the electronic circuit to have one or more operating parameters that meet one or more desired operating parameters of the electronic circuit; determining, based on the testing of the electronic circuit, capacitance values for one or more fixed-value capacitors to replace the one or more variable capacitors in the electronic circuit, each of the fixed-value capacitors having a second capacitance value equivalent to the first value of the corresponding variable capacitor.

In some aspects, the techniques described herein relate to a method wherein the electronic circuit is an amplifier circuit.

In some aspects, the techniques described herein relate to a method wherein the electronic circuit is a low-noise amplifier circuit.

In some aspects, the techniques described herein relate to a method wherein at least one of the desired operating parameters are defined as a range of values.

In some aspects, the techniques described herein relate to a method wherein at least one of the desired operating parameters are defined as one or more fixed values, each of the fixed values having an error margin.

In some aspects, the techniques described herein relate to a method wherein the capacitance of at least one of the variable capacitors is adjusted to change a shunt capacitance of at least one part of the electronic circuit to cause the electronic circuit to have one or more operating parameters that meet one or more desired operating parameters of the electronic circuit.

In some aspects, the techniques described herein relate to a method wherein the capacitance of at least one of the variable capacitors is adjusted to change a series capacitance of at least one part of the electronic circuit to cause the electronic circuit to have one or more operating parameters that meet one or more desired operating parameters of the electronic circuit.

In some aspects, the techniques described herein relate to a method wherein at least one of the operating parameters is dependent on an internal capacitance of at least one component of the electronic circuit.

In some aspects, the techniques described herein relate to a method wherein at least one of the operating parameters is dependent on at least one parasitic capacitance that exists between two parts of the electronic circuit.

In some aspects, the techniques described herein relate to a method wherein at least one of the operating parameters is dependent on at least one parasitic capacitance that exists between at least one part of the electronic circuit and an external device or an external component electrically connected to the at least one part of the electronic circuit.

In some aspects, the techniques described herein relate to a method wherein at least one of the operating parameters is dependent on at least one parasitic capacitance that exists between at least one part of the electronic circuit and a device or a component located adjacent to the at least one part of the electronic circuit.

In some aspects, the techniques described herein relate to a method wherein the operating parameters include at least one frequency at which at least one part of the electronic circuit oscillates, and the desired operating parameters include at least one desired frequency at which the at least one part of the electronic circuit oscillates.

In some aspects, the techniques described herein relate to a method wherein the at least one desired frequency is defined in a form of a minimum or a maximum frequency, or a range of frequencies.

In some aspects, the techniques described herein relate to a method wherein at least one of the variable capacitors is configured to function as a decoupling capacitor for decoupling a first part of the electronic circuit from a second part of the electronic circuit.

In some aspects, the techniques described herein relate to a method wherein the variable capacitor is configured to prevent a current drawn by the first part from causing a voltage change to affect the operation of the second part of the electronic circuit.

In some aspects, the techniques described herein relate to a method wherein the first and second parts of the electronic circuit have a common power source.

In some aspects, the techniques described herein relate to a method wherein the first and second parts of the electronic circuits are coupled through a common impedance to a common power source.

In some aspects, the techniques described herein relate to a method wherein the variable capacitor is configured to prevent radiation of electromagnetic interference between the first and second parts of the electronic circuit.

In some aspects, the techniques described herein relate to a method wherein the electromagnetic interference is caused by change of a power supply current.

In some aspects, the techniques described herein relate to a method wherein at least one of the variable capacitors is configured to function as a decoupling capacitor for decoupling at least one part of the electronic circuit and an external device or an external component electrically connected to the at least one part of the electronic circuit.

In some aspects, the techniques described herein relate to a method wherein the variable capacitor is configured to prevent a current drawn by the at least one part of the electronic circuit from causing a voltage change to affect the operation of the external device or the external component.

In some aspects, the techniques described herein relate to a method wherein the variable capacitor is configured to prevent a current drawn by the external device or the external component from causing a voltage change to affect the operation of the at least one part of the electronic circuit.

In some aspects, the techniques described herein relate to a method wherein the at least one part of the electronic circuit and the external device or the external component have a common power source.

In some aspects, the techniques described herein relate to a method wherein the first and second parts of the electronic circuits are coupled through a common impedance to a common power source.

In some aspects, the techniques described herein relate to a method wherein the variable capacitor is configured to prevent radiation of electromagnetic interference between the at least one part of the electronic circuit and the external device or the external component.

In some aspects, the techniques described herein relate to a method wherein the electromagnetic interference is cause by change of a power supply current.

In some aspects, the techniques described herein relate to a method wherein at least one of the variable capacitors is configured to function as a bypass capacitor to decouple an AC signal from a first part of the electronic circuit from a second part of the electronic circuit.

In some aspects, the techniques described herein relate to a method wherein at least one of the variable capacitors is configured to function as a bypass capacitor to decouple a voltage spike and/or a voltage dip from a first part of the electronic circuit from a second part of the electronic circuit.

In some aspects, the techniques described herein relate to a method wherein at least one of the variable capacitors has a variable capacitance between a first node and a second node, the variable capacitor including: a switch having a first terminal and a second terminal, an impedance between the first terminal and the second terminal being controllable via a first control node, the switch including two or more transistors; a first capacitor coupled between the first terminal and the first node; and a second capacitor coupled between the second terminal and the second node.

In some aspects, the techniques described herein relate to a method wherein the capacitance of the variable capacitor is adjusted using a controller.

In some aspects, the techniques described herein relate to a method wherein the controller is configured to automatically adjust the capacitance of the variable capacitor and determine the one or more first capacitance values of the one or more variable capacitors that cause the electronic circuit to have the one or more operating parameters that meet the one or more desired operating parameters of the electronic circuit.

In some aspects, the techniques described herein relate to a computer implemented method for designing a prototype electronic circuit, the method including: with one or more processors, generating a software model of a prototype electronic circuit that includes one or more capacitors and one or more other components; with one or more processors, estimating a range of capacitance values for at least one of the capacitors in order for the electronic circuit to meet one or more desired operating parameters, the range of capacitance values used to select a variable capacitor having said variable capacitance range for inclusion in the electronic circuit at the location of the at least one of the capacitors.

In some aspects, the techniques described herein relate to an electronic circuit including: a first set of one or more capacitors and a first set of one or more additional components, the capacitance values of the first set of one or more capacitors being determined by: providing a prototype electronic circuit including a second set of one or more capacitors and a second set of one or more other components, at least one of the second set of one or more capacitors being a variable capacitor; testing the prototype electronic circuit by adjusting the capacitance of the one or more variable capacitors to determine one or more first capacitance values of the one or more variable capacitors that cause the prototype electronic circuit to have one or more operating parameters that meet one or more desired operating parameters of the electronic circuit; and determining, based on the testing of the prototype electronic circuit, capacitance values for one or more fixed-value capacitors to replace the one or more variable capacitors in the prototype electronic circuit, each of the fixed-value capacitors having a second capacitance value equivalent to the first value of the corresponding variable capacitor.

In some aspects, the techniques described herein relate to an electronic circuit including a controller for adjusting the capacitance of the variable capacitor.

In some aspects, the techniques described herein relate to a radio frequency module including: a packaging substrate configured to receive a plurality of components; and an electronic circuit including: one or more capacitors, at least one of the capacitors being a variable capacitor having a variable capacitance range determined by estimating a range of capacitance values for at least one of the capacitors in order for the electronic circuit to meet one or more desired operating parameters and determining a variable capacitance range of the variable capacitor that encompasses the range of capacitance values; and one or more additional components; the electronic circuit being implemented on the packaging substrate.

In some aspects, the techniques described herein relate to a radio frequency module wherein the radio frequency module is a front end module.

In some aspects, the techniques described herein relate to a radio frequency module wherein the electronic circuit is one of an amplifier circuit or a low-noise amplifier circuit.

In some aspects, the techniques described herein relate to a wireless device including: a transceiver configured to generate a radio frequency signal; a front end module in communication with the transceiver, the front end module including a packaging substrate configured to receive a plurality of components, said front end module including an electronic circuit, the electronic circuit including: one or more capacitors, at least one of the capacitors being a variable capacitor having a variable capacitance range determined by estimating a range of capacitance values for at least one of the capacitors in order for the electronic circuit to meet one or more desired operating parameters and determining a variable capacitance range of the variable capacitor that encompasses the range of capacitance values; and one or more additional components; the electronic circuit being implemented on the packaging substrate; and an antenna in communication with the front end module, the antenna configured to transmit the amplified radio frequency signal.

In some aspects, the techniques described herein relate to a method for designing an electronic circuit the method including: providing a prototype electronic circuit including one or more passive components and one or more active components, at least one of the one or more passive components having a variable value; testing the electronic circuit by adjusting value of the one or more passive components to determine one or more first values of the one or more passive components that cause the electronic circuit to have one or more operating parameters that meet one or more desired operating parameters of the electronic circuit; determining, based on the testing of the electronic circuit, values for one or more fixed-value passive components to replace the one or more variable passive components in the electronic circuit, each of the fixed-value passive components having a second value equivalent to the first value of the corresponding variable passive component.

In some aspects, the techniques described herein relate to a method wherein the electronic circuit is an amplifier circuit.

In some aspects, the techniques described herein relate to a method wherein at least one of the desired operating parameters are defined as one or more fixed values, each of the fixed values having an error margin.

In some aspects, the techniques described herein relate to a method wherein the one or more passive components having a variable value include one or more capacitors.

In some aspects, the techniques described herein relate to a method wherein the one or more passive components having a variable value include one or more resistors.

In some aspects, the techniques described herein relate to a method wherein the one or more passive components having a variable value include one or more inductors.

In some aspects, the techniques described herein relate to a method wherein the value of the variable passive components is adjusted using a controller.

In some aspects, the techniques described herein relate to a method wherein the controller is configured to automatically adjust the values of the variable passive component and determine the one or more first values of the one or more variable passive components that cause the electronic circuit to have the one or more operating parameters that meet the one or more desired operating parameters of the electronic circuit.

In some aspects, the techniques described herein relate to a computer implemented method for designing a prototype electronic circuit, the method including: with one or more processors, generating a software model of a prototype electronic circuit that includes one or more passive components and one or more other active; and with one or more processors, estimating a range of values for at least one of the passive components in order for the electronic circuit to meet one or more desired operating parameters, the range of values used to select a variable passive component having said range of values for inclusion in the electronic circuit at the location of the at least one of the passive components. In some aspects, the passive components include one or more capacitors. In some aspects, the passive components include one or more resistors. In some aspects, the passive components include one or more inductors.

In some aspects, the techniques described herein relate to a method for designing an electronic circuit the method including: providing a prototype electronic circuit including one or more capacitors, one or more resistors, and one or more other components, at least one of the one or more capacitors being a variable capacitor and at least one of the one or more resistors being a variable resistor; testing the electronic circuit by adjusting the capacitance of the one or more variable capacitors and the resistance of the one or more resistors to determine one or more first capacitance values and one or more first resistance values of the one or more variable capacitors and the one or more variable resistors, respectively, that cause the electronic circuit to have one or more operating parameters that meet one or more desired operating parameters of the electronic circuit; and determining, based on the testing of the electronic circuit, capacitance values and resistance values for one or more fixed-value capacitors and one or more fixed value resistors, respectively, to replace the one or more one or more variable capacitors and the one or more variable resistors in the electronic circuit, respectively, each of the fixed-value capacitors having a second capacitance value equivalent to the first capacitance value of the corresponding variable capacitor, and each of the fixed-value resistors having a second resistor value equivalent to the first resistance value of the corresponding variable capacitor.

In some aspects, the techniques described herein relate to a method wherein the electronic circuit is an amplifier circuit.

In some aspects, the techniques described herein relate to a method wherein the electronic circuit is a low-noise amplifier circuit.

In some aspects, the techniques described herein relate to a method wherein at least one of the desired operating parameters are defined as a range of values.

In some aspects, the techniques described herein relate to a method wherein at least one of the desired operating parameters are defined as one or more fixed values, each of the fixed values having an error margin.

In some aspects, the techniques described herein relate to a method wherein the capacitance of at least one of the variable capacitors is adjusted to change a shunt capacitance of at least one part of the electronic circuit to cause the electronic circuit to have one or more operating parameters that meet one or more desired operating parameters of the electronic circuit.

In some aspects, the techniques described herein relate to a method wherein the capacitance of at least one of the variable capacitors is adjusted to change a series capacitance of at least one part of the electronic circuit to cause the electronic circuit to have one or more operating parameters that meet one or more desired operating parameters of the electronic circuit.

In some aspects, the techniques described herein relate to a method wherein at least one of the operating parameters is dependent on an internal capacitance of at least one component of the electronic circuit.

In some aspects, the techniques described herein relate to a method wherein at least one of the operating parameters is dependent on at least one parasitic capacitance that exists between two parts of the electronic circuit.

In some aspects, the techniques described herein relate to a method wherein at least one of the operating parameters is dependent on at least one parasitic capacitance that exists between at least one part of the electronic circuit and an external device or an external component electrically connected to the at least one part of the electronic circuit.

In some aspects, the techniques described herein relate to a method wherein at least one of the operating parameters is dependent on at least one parasitic capacitance that exists between at least one part of the electronic circuit and a device or a component located adjacent to the at least one part of the electronic circuit.

In some aspects, the techniques described herein relate to a method wherein the operating parameters include at least one frequency at which at least one part of the electronic circuit oscillates, and the desired operating parameters include at least one desired frequency at which the at least one part of the electronic circuit oscillates.

In some aspects, the techniques described herein relate to a method wherein the at least one desired frequency is defined in a form of a minimum or a maximum frequency, or a range of frequencies.

In some aspects, the techniques described herein relate to a method wherein at least one of the variable capacitors is configured to function as a decoupling capacitor for decoupling a first part of the electronic circuit from a second part of the electronic circuit.

In some aspects, the techniques described herein relate to a method wherein the variable capacitor is configured to prevent a current drawn by the first part from causing a voltage change to affect the operation of the second part of the electronic circuit.

In some aspects, the techniques described herein relate to a method wherein the first and second parts of the electronic circuit have a common power source.

In some aspects, the techniques described herein relate to a method wherein the first and second parts of the electronic circuits are coupled through a common impedance to a common power source.

In some aspects, the techniques described herein relate to a method wherein the variable capacitor is configured to prevent radiation of electromagnetic interference between the first and second parts of the electronic circuit.

In some aspects, the techniques described herein relate to a method wherein the electromagnetic interference is caused by change of a power supply current.

In some aspects, the techniques described herein relate to a method wherein at least one of the variable capacitors is configured to function as a decoupling capacitor for decoupling at least one part of the electronic circuit and an external device or an external component electrically connected to the at least one part of the electronic circuit.

In some aspects, the techniques described herein relate to a method wherein the variable capacitor is configured to prevent a current drawn by the at least one part of the electronic circuit from causing a voltage change to affect the operation of the external device or the external component.

In some aspects, the techniques described herein relate to a method wherein the variable capacitor is configured to prevent a current drawn by the external device or the external component from causing a voltage change to affect the operation of the at least one part of the electronic circuit.

In some aspects, the techniques described herein relate to a method wherein the at least one part of the electronic circuit and the external device or the external component have a common power source.

In some aspects, the techniques described herein relate to a method wherein the first and second parts of the electronic circuits are coupled through a common impedance to a common power source.

In some aspects, the techniques described herein relate to a method wherein the variable capacitor is configured to prevent radiation of electromagnetic interference between the at least one part of the electronic circuit and the external device or the external component.

In some aspects, the techniques described herein relate to a method wherein the electromagnetic interference is cause by change of a power supply current.

In some aspects, the techniques described herein relate to a method wherein at least one of the variable capacitors is configured to function as a bypass capacitor to decouple an AC signal from a first part of the electronic circuit from a second part of the electronic circuit.

In some aspects, the techniques described herein relate to a method wherein at least one of the variable capacitors is configured to function as a bypass capacitor to decouple a voltage spike and/or a voltage dip from a first part of the electronic circuit from a second part of the electronic circuit.

In some aspects, the techniques described herein relate to a method wherein at least one of the variable capacitors has a variable capacitance between a first node and a second node, the variable capacitor including: a switch having a first terminal and a second terminal, an impedance between the first terminal and the second terminal being controllable via a first control node, the switch including two or more transistors; a first capacitor coupled between the first terminal and the first node; and a second capacitor coupled between the second terminal and the second node.

In some aspects, the techniques described herein relate to a method wherein the capacitance of the variable capacitor is adjusted using a controller.

In some aspects, the techniques described herein relate to a method wherein the controller is configured to automatically adjust the capacitance of the variable capacitor and determine the one or more first capacitance values of the one or more variable capacitors that cause the electronic circuit to have the one or more operating parameters that meet the one or more desired operating parameters of the electronic circuit.

In some aspects, the techniques described herein relate to a method wherein at least one of the variable resistors have a high resistance value prior to adjusting the capacitance of at least one of the variable capacitors and/or the resistance of at least one of the variable resistors in order to minimize the impact of the at least one of the variable resistors on at least one of the operating parameters of the electronic circuit.

In some aspects, the techniques described herein relate to a method wherein at least one of the variable resistors have a resistance value greater than 20 kΩ prior to adjusting the capacitance of at least one of the variable capacitors and/or the resistance of at least one of the variable resistors.

In some aspects, the techniques described herein relate to a method wherein the resistance of at least one of the variable resistors are adjusted by decreasing the resistance value from the high resistance value.

In some aspects, the techniques described herein relate to a method wherein at least one of the variable resistors have a low resistance value prior to adjusting the capacitance of at least one of the variable capacitors and/or the resistance of at least one of the variable resistors in order to minimize the impact of the at least one of the variable resistors on at least one of the operating parameters of the electronic circuit.

In some aspects, the techniques described herein relate to a method wherein at least one of the variable resistors have a resistance value smaller than 1Ω prior to adjusting the capacitance of at least one of the variable capacitors and/or the resistance of at least one of the variable resistors.

In some aspects, the techniques described herein relate to a method wherein the resistance of at least one of the variable resistors are adjusted by increasing the resistance value from the low resistance value.

In some aspects, the techniques described herein relate to a method wherein the resistance of at least one of the variable resistors are adjusted to reduce a quality factor of the electronic circuit.

In some aspects, the techniques described herein relate to a method wherein at least one of the variable resistors are digitally programmable.

In some aspects, the techniques described herein relate to a computer implemented method for designing a prototype electronic circuit, the method including, with one or more processors: generating a software model of a prototype electronic circuit that includes one or more capacitors, one or more resistors, and one or more other components; estimating a range of capacitance values for at least one of the capacitors in order for the electronic circuit to meet one or more desired operating parameters, the range of capacitance values used to select a variable capacitor having said variable capacitance range for inclusion in the electronic circuit at the location of the at least one of the capacitors; and estimating a range of resistance values for at least one of the resistors in order for the electronic circuit to meet one or more desired operating parameters, the range of resistance values used to select a variable resistor having said variable resistance range for inclusion in the electronic circuit at the location of the at least one of the resistors.

In some aspects, the techniques described herein relate to an electronic circuit including: a first set of one or more capacitors, a first set of one or more resistors and a first set of one or more additional components, the capacitance values of the first set of one or more capacitors and the resistance values of the first set of one or more resistors being determined by: providing a prototype electronic circuit including a second set of one or more capacitors, a second set of one or more resistors and a second set of one or more other components, at least one of the second set of one or more capacitors being a variable capacitor and at least one of the second set of one or more resistors being a variable resistor; testing the prototype electronic circuit by adjusting the capacitance of the one or more variable capacitors to determine one or more first capacitance values of the one or more variable capacitors and the resistance of the one or more variable resistors to determine one or more first resistance values of the one or more variable resistors that cause the prototype electronic circuit to have one or more operating parameters that meet one or more desired operating parameters of the electronic circuit; and determining, based on the testing of the prototype electronic circuit, capacitance values for one or more fixed-value capacitors to replace the one or more variable capacitors in the prototype electronic circuit and resistance values for one or more fixed-value resistors to replace the one or more variable resistors in the prototype electronic circuit, each of the fixed-value capacitors having a second capacitance value equivalent to the first value of the corresponding variable capacitor and each of the fixed-value resistors having a second resistance value equivalent to the first value of the corresponding variable resistor.

In some aspects, the techniques described herein relate to an electronic circuit including a controller for adjusting the capacitance of the variable capacitor and/or the resistance of the variable resistors.

In some aspects, the techniques described herein relate to a radio frequency module including: a packaging substrate configured to receive a plurality of components; and an electronic circuit including: one or more capacitors, at least one of the capacitors being a variable capacitor having a variable capacitance range determined by estimating a range of capacitance values for at least one of the capacitors in order for the electronic circuit to meet one or more desired operating parameters and determining a variable capacitance range of the variable capacitor that encompasses the range of capacitance values; one or more resistors, at least one of the resistors being a variable resistor having a variable resistance range determined by estimating a range of resistance values for at least one of the resistors in order for the electronic circuit to meet one or more desired operating parameters and determining a variable resistance range of the variable resistor that encompasses the range of resistance values; and one or more additional components; the electronic circuit being implemented on the packaging substrate.

In some aspects, the techniques described herein relate to a radio frequency module wherein the radio frequency module is a front end module.

In some aspects, the techniques described herein relate to a radio frequency module wherein the electronic circuit is one of an amplifier circuit or a low-noise amplifier circuit.

In some aspects, the techniques described herein relate to a wireless device including: a transceiver configured to generate a radio frequency signal; a front end module in communication with the transceiver, the front end module including a packaging substrate configured to receive a plurality of components, said front end module including an electronic circuit, the electronic circuit including: one or more capacitors, at least one of the capacitors being a variable capacitor having a variable capacitance range determined by estimating a range of capacitance values for at least one of the capacitors in order for the electronic circuit to meet one or more desired operating parameters and determining a variable capacitance range of the variable capacitor that encompasses the range of capacitance values; one or more resistors, at least one of the resistors being a variable resistor having a variable resistance range determined by estimating a range of resistance values for at least one of the resistors in order for the electronic circuit to meet one or more desired operating parameters and determining a variable resistance range of the variable resistor that encompasses the range of resistance values; and one or more additional components; the electronic circuit being implemented on the packaging substrate; and an antenna in communication with the front end module, the antenna configured to transmit the amplified radio frequency signal.

In some aspects, the techniques described herein relate to a method for designing an electronic circuit the method including: providing a prototype electronic circuit including one or more capacitors, one or more inductors, and one or more other components, at least one of the one or more capacitors being a variable capacitor and at least one of the one or more inductors being a variable inductor; testing the electronic circuit by adjusting the capacitance of the one or more variable capacitors to determine one or more first capacitance values of the one or more variable capacitors that cause the electronic circuit to have one or more operating parameters that meet one or more desired operating parameters of the electronic circuit; testing the electronic circuit by adjusting the inductance of the one or more variable inductors to determine one or more first inductance values of the one or more variable inductance that cause the electronic circuit to have one or more operating parameters that meet one or more desired operating parameters of the electronic circuit; determining, based on the testing of the electronic circuit, capacitance values for one or more fixed-value capacitors to replace the one or more variable capacitors in the electronic circuit, each of the fixed-value capacitors having a second capacitance value equivalent to the first value of the corresponding variable capacitor; and determining, based on the testing of the electronic circuit, inductance values for one or more fixed-value inductors to replace the one or more variable inductors in the electronic circuit, each of the fixed-value inductors having a second inductance value equivalent to the first value of the corresponding variable inductors.

In some aspects, the techniques described herein relate to a method wherein the electronic circuit is an amplifier circuit.

In some aspects, the techniques described herein relate to a method wherein the electronic circuit is a low-noise amplifier circuit.

In some aspects, the techniques described herein relate to a method wherein at least one of the desired operating parameters are defined as a range of values.

In some aspects, the techniques described herein relate to a method wherein at least one of the desired operating parameters are defined as one or more fixed values, each of the fixed values having an error margin.

In some aspects, the techniques described herein relate to a method wherein the capacitance of at least one of the variable capacitors is adjusted to change a shunt capacitance of at least one part of the electronic circuit to cause the electronic circuit to have one or more operating parameters that meet one or more desired operating parameters of the electronic circuit.

In some aspects, the techniques described herein relate to a method wherein the capacitance of at least one of the variable capacitors is adjusted to change a series capacitance of at least one part of the electronic circuit to cause the electronic circuit to have one or more operating parameters that meet one or more desired operating parameters of the electronic circuit.

In some aspects, the techniques described herein relate to a method wherein at least one of the operating parameters is dependent on an internal capacitance of at least one component of the electronic circuit.

In some aspects, the techniques described herein relate to a method wherein at least one of the operating parameters is dependent on at least one parasitic capacitance that exists between two parts of the electronic circuit.

In some aspects, the techniques described herein relate to a method wherein at least one of the operating parameters is dependent on at least one parasitic capacitance that exists between at least one part of the electronic circuit and an external device or an external component electrically connected to the at least one part of the electronic circuit.

In some aspects, the techniques described herein relate to a method wherein at least one of the operating parameters is dependent on at least one parasitic capacitance that exists between at least one part of the electronic circuit and a device or a component located adjacent to the at least one part of the electronic circuit.

In some aspects, the techniques described herein relate to a method wherein the operating parameters include at least one frequency at which at least one part of the electronic circuit oscillates, and the desired operating parameters include at least one desired frequency at which the at least one part of the electronic circuit oscillates.

In some aspects, the techniques described herein relate to a method wherein the at least one desired frequency is defined in a form of a minimum or a maximum frequency, or a range of frequencies.

In some aspects, the techniques described herein relate to a method wherein at least one of the variable capacitors is configured to function as a decoupling capacitor for decoupling a first part of the electronic circuit from a second part of the electronic circuit.

In some aspects, the techniques described herein relate to a method wherein the variable capacitor is configured to prevent a current drawn by the first part from causing a voltage change to affect the operation of the second part of the electronic circuit.

In some aspects, the techniques described herein relate to a method wherein the first and second parts of the electronic circuit have a common power source.

In some aspects, the techniques described herein relate to a method wherein the first and second parts of the electronic circuits are coupled through a common impedance to a common power source.

In some aspects, the techniques described herein relate to a method wherein the variable capacitor is configured to prevent radiation of electromagnetic interference between the first and second parts of the electronic circuit.

In some aspects, the techniques described herein relate to a method wherein the electromagnetic interference is caused by change of a power supply current.

In some aspects, the techniques described herein relate to a method wherein at least one of the variable capacitors is configured to function as a decoupling capacitor for decoupling at least one part of the electronic circuit and an external device or an external component electrically connected to the at least one part of the electronic circuit.

In some aspects, the techniques described herein relate to a method wherein the variable capacitor is configured to prevent a current drawn by the at least one part of the electronic circuit from causing a voltage change to affect the operation of the external device or the external component.

In some aspects, the techniques described herein relate to a method wherein the variable capacitor is configured to prevent a current drawn by the external device or the external component from causing a voltage change to affect the operation of the at least one part of the electronic circuit.

In some aspects, the techniques described herein relate to a method wherein the at least one part of the electronic circuit and the external device or the external component have a common power source.

In some aspects, the techniques described herein relate to a method wherein the first and second parts of the electronic circuits are coupled through a common impedance to a common power source.

In some aspects, the techniques described herein relate to a method wherein the variable capacitor is configured to prevent radiation of electromagnetic interference between the at least one part of the electronic circuit and the external device or the external component.

In some aspects, the techniques described herein relate to a method wherein the electromagnetic interference is cause by change of a power supply current.

In some aspects, the techniques described herein relate to a method wherein at least one of the variable capacitors is configured to function as a bypass capacitor to decouple an AC signal from a first part of the electronic circuit from a second part of the electronic circuit.

In some aspects, the techniques described herein relate to a method wherein at least one of the variable capacitors is configured to function as a bypass capacitor to decouple a voltage spike and/or a voltage dip from a first part of the electronic circuit from a second part of the electronic circuit.

In some aspects, the techniques described herein relate to a method wherein at least one of the variable capacitors has a variable capacitance between a first node and a second node, the variable capacitor including: a switch having a first terminal and a second terminal, an impedance between the first terminal and the second terminal being controllable via a first control node, the switch including two or more transistors; a first capacitor coupled between the first terminal and the first node; and a second capacitor coupled between the second terminal and the second node.

In some aspects, the techniques described herein relate to a method wherein the capacitance of the variable capacitor is adjusted using a controller.

In some aspects, the techniques described herein relate to a method wherein the controller is configured to automatically adjust the capacitance of the variable capacitor and determine the one or more first capacitance values of the one or more variable capacitors that cause the electronic circuit to have the one or more operating parameters that meet the one or more desired operating parameters of the electronic circuit.

In some aspects, the techniques described herein relate to a method wherein at least one of the variable inductors have a high inductance value prior to adjusting the capacitance of at least one of the variable capacitors and/or the impedance of at least one of the variable inductors in order to minimize the impact of the at least one of the variable inductors on at least one of the operating parameters of the electronic circuit.

In some aspects, the techniques described herein relate to a method wherein the inductance of at least one of the variable inductors are adjusted by decreasing the inductance value from the high inductance value.

In some aspects, the techniques described herein relate to a method wherein at least one of the variable inductors have a low inductance value prior to adjusting the capacitance of at least one of the variable capacitors and/or the inductance of at least one of the variable inductors in order to minimize the impact of the at least one of the variable inductors on at least one of the operating parameters of the electronic circuit.

In some aspects, the techniques described herein relate to a method wherein the inductance of at least one of the variable inductors are adjusted by increasing the inductance value from the low inductance value.

In some aspects, the techniques described herein relate to a method wherein at least one of the variable inductors are digitally programmable.

In some aspects, the techniques described herein relate to a computer implemented method for designing a prototype electronic circuit that includes one or more capacitors, one or more inductors, and one or more other components the method including, with one or more processors: with one or more processors: generating a software model of a prototype electronic circuit that includes one or more capacitors, one or more resistors, and one or more other components; estimating a range of capacitance values for at least one of the capacitors in order for the electronic circuit to meet one or more desired operating parameters, the range of capacitance values used to select a variable capacitor having said variable capacitance range for inclusion in the electronic circuit at the location of the at least one of the capacitors; and estimating a range of inductance values for at least one of the inductors in order for the electronic circuit to meet one or more desired operating parameters, the range of inductance values used to select a variable inductor having said inductance resistance range for inclusion in the electronic circuit at the location of the at least one of the inductors.

In some aspects, the techniques described herein relate to an electronic circuit including: a first set of one or more capacitors, a first set of one or more inductors and a first set of one or more additional components, the capacitance values of the first set of one or more capacitors and the inductance values of the first set of one or more inductors being determined by: providing a prototype electronic circuit including a second set of one or more capacitors, a second set of one or more inductors and a second set of one or more other components, at least one of the second set of one or more capacitors being a variable capacitor and at least one of the second set of one or more inductors being a variable inductor; testing the prototype electronic circuit by adjusting the capacitance of the one or more variable capacitors to determine one or more first capacitance values of the one or more variable capacitors and the inductance of the one or more variable inductors to determine one or more first inductance values of the one or more variable inductors that cause the prototype electronic circuit to have one or more operating parameters that meet one or more desired operating parameters of the electronic circuit; and determining, based on the testing of the prototype electronic circuit, capacitance values for one or more fixed-value capacitors to replace the one or more variable capacitors in the prototype electronic circuit and inductance values for one or more fixed-value inductors to replace the one or more variable inductors in the prototype electronic circuit, each of the fixed-value capacitors having a second capacitance value equivalent to the first value of the corresponding variable capacitor and each of the fixed-value inductors having a second inductance value equivalent to the first value of the corresponding variable inductor.

In some aspects, the techniques described herein relate to an electronic circuit including a controller for adjusting the capacitance of the variable capacitor and/or the inductance of the variable inductors.

In some aspects, the techniques described herein relate to a radio frequency module including: a packaging substrate configured to receive a plurality of components; and an electronic circuit including: one or more capacitors, at least one of the capacitors being a variable capacitor having a variable capacitance range determined by estimating a range of capacitance values for at least one of the capacitors in order for the electronic circuit to meet one or more desired operating parameters and determining a variable capacitance range of the variable capacitor that encompasses the range of capacitance values; one or more inductors, at least one of the inductors being a variable inductors having a variable inductance range determined by estimating a range of inductance values for at least one of the inductance in order for the electronic circuit to meet one or more desired operating parameters and determining a variable inductance range of the variable inductor that encompasses the range of inductance values; and one or more additional components; the electronic circuit being implemented on the packaging substrate.

In some aspects, the techniques described herein relate to a radio frequency module wherein the radio frequency module is a front end module.

In some aspects, the techniques described herein relate to a radio frequency module wherein the electronic circuit is one of an amplifier circuit or a low-noise amplifier circuit.

In some aspects, the techniques described herein relate to a wireless device including: a transceiver configured to generate a radio frequency signal; a front end module in communication with the transceiver, the front end module including a packaging substrate configured to receive a plurality of components, said front end module including an electronic circuit, the electronic circuit including: one or more capacitors, at least one of the capacitors being a variable capacitor having a variable capacitance range determined by estimating a range of capacitance values for at least one of the capacitors in order for the electronic circuit to meet one or more desired operating parameters and determining a variable capacitance range of the variable capacitor that encompasses the range of capacitance values; one or more inductors, at least one of the inductors being a variable inductors having a variable inductance range determined by estimating a range of inductance values for at least one of the inductance in order for the electronic circuit to meet one or more desired operating parameters and determining a variable inductance range of the variable inductor that encompasses the range of inductance values; and one or more additional components; the electronic circuit being implemented on the packaging substrate; and an antenna in communication with the front end module, the antenna configured to transmit the amplified radio frequency signal.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a circuit diagram of an exemplary prototype electronic circuit according to an embodiment;

FIG. 2 is a Smith Chart illustrating an example of how capacitance of one or more variable capacitors of an exemplary prototype electronic circuit may be adjusted to cause changes of one or more operating parameters of the prototype electronic circuit according to an embodiment;

FIG. 3 is a circuit diagram of an exemplary prototype electronic circuit according to an embodiment;

FIG. 4 is a circuit diagram of an exemplary prototype electronic circuit according to an embodiment;

FIG. 5 is an exemplary power-frequency graph of a prototype electronic circuit illustrating an exemplary power gain response;

FIG. 6 is a circuit diagram of an exemplary prototype electronic circuit according to an embodiment;

FIG. 7 is a circuit diagram of an exemplary prototype electronic circuit according to an embodiment;

FIG. 8A is a process flow diagram showing steps for designing an electronic circuit according to an embodiment;

FIG. 8B is a process flow diagram showing steps for designing a prototype electronic circuit according to an embodiment;

FIG. 8C is a process flow diagram showing steps for designing an electronic circuit according to an embodiment;

FIG. 8D is a process flow diagram showing steps for designing a prototype electronic circuit according to an embodiment;

FIG. 8E is a process flow diagram showing steps for designing an electronic circuit according to an embodiment;

FIG. 8F is a process flow diagram showing steps for designing a prototype electronic circuit according to an embodiment;

FIG. 8G is a process flow diagram showing steps for designing an electronic circuit according to an embodiment;

FIG. 8H is a process flow diagram showing steps for designing a prototype electronic circuit according to an embodiment;

FIG. 8I is a process flow diagram showing operations performed by CAD, simulation, and/or modeling software according to certain embodiments.

FIG. 8J is an example of a computer system with CAD, simulation, and/or modeling software for designing, simulating, and or modeling circuitry according to certain embodiments.

FIG. 9 is a circuit diagram of an example variable capacitor according to an embodiment;

FIG. 10A is a circuit diagram of an example variable capacitor that includes a transistor as part of a switch disposed between two capacitors according to an embodiment;

FIG. 10B is a circuit diagram of an example variable capacitor that includes multiple transistors as part of a switch disposed between two capacitors according to an embodiment;

FIG. 11A is a circuit diagram of the variable capacitor of FIG. 9 in an on state according to an embodiment;

FIG. 11B is a circuit diagram of the variable capacitor of FIG. 9 in an off state according to an embodiment;

FIG. 12 is a circuit diagram of an example variable capacitor configuration that includes multiple variable capacitance elements in parallel according to an embodiment;

FIG. 13 is a circuit diagram of an example variable capacitor configuration that includes multiple variable capacitance elements and transistors in parallel according to an embodiment;

FIG. 14 is an example packed module comprising a prototype electronic circuit according to an embodiment; and

FIG. 15 is an example wireless device comprising a prototype electronic circuit according to an embodiment.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

According to a number of embodiments of a first aspect, the invention provides a method for designing an electronic circuit, such as an amplifier circuit or a low-noise amplifier (LNA) circuit. The method for designing an electronic circuit comprises providing a prototype electronic circuit comprising one or more capacitors and one or more other components, at least one of the one or more capacitors being a variable capacitor; testing the electronic circuit by adjusting the capacitance of the variable capacitors to determine one or more first values of the variable capacitors that cause the electronic circuit to have one or more operating parameters that meet one or more desired operating parameters of the electronic circuit; and determining, based on the testing of the electronic circuit, capacitance values for one or more fixed-value capacitors to replace the one or more variable capacitors in the electronic circuit, each of the fixed-value capacitors having a second capacitance value equivalent to the first value of the corresponding variable capacitor.

A method for designing the said prototype electronic circuit according to the first aspect is also provided. The method for designing a prototype electronic circuit comprises: estimating a range of capacitance values for at least one of the capacitors in order for the electronic circuit to meet one or more desired operating parameters; determining a variable capacitance range of a variable capacitor that encompasses the range of capacitance values; and selecting a variable capacitor having said variable capacitance range for inclusion in the electronic circuit at the location of the at least one of the capacitors.

A corresponding electronic circuit, according to the first aspect, comprising one or more capacitors and one or more additional components is also provided. At least one of the capacitors of the electronic circuit is a variable capacitor having a variable capacitance range. The variable capacitance range is determined by estimating a range of capacitance values for at least one of the capacitors in order for the electronic circuit to meet one or more desired operating parameters, and determining a variable capacitance range of the variable capacitor that encompasses the range of capacitance values.

A radio frequency module and wireless device comprising such an electronic circuit according to the first aspect are also provided.

According to a number of embodiments of a second aspect, the invention provides a method for designing an electronic circuit, such as an amplifier circuit or a low-noise amplifier (LNA) circuit. The method for designing an electronic circuit comprises providing a prototype electronic circuit comprising one or more capacitors, one or more resistors, and one or more other components, at least one of the one or more capacitors being a variable capacitor and at least one of the one or more resistors being a variable resistor; testing the electronic circuit by adjusting the capacitance of the variable capacitors to determine one or more first values of the variable capacitors that cause the electronic circuit to have one or more operating parameters that meet one or more desired operating parameters of the electronic circuit; testing the electronic circuit by adjusting the resistance of the variable resistors to determine one or more first values of the variable resistors that cause the electronic circuit to have one or more operating parameters that meet one or more desired operating parameters of the electronic circuit; determining, based on the testing of the electronic circuit, capacitance values for one or more fixed-value capacitors to replace the one or more variable capacitors in the electronic circuit, each of the fixed-value capacitors having a second capacitance value equivalent to the first value of the corresponding variable capacitor; and determining, based on the testing of the electronic circuit, resistance values for one or more fixed-value resistors to replace the one or more variable resistors in the electronic circuit, each of the fixed-value resistors having a second resistance value equivalent to the first value of the corresponding variable resistor.

A method for designing the said prototype electronic circuit according to the second aspect is also provided. The method for designing a prototype electronic circuit comprises: estimating a range of capacitance values for at least one of the capacitors in order for the electronic circuit to meet one or more desired operating parameters; estimating a range of resistance values for at least one of the resistors in order for the electronic circuit to meet one or more desired operating parameters; determining a variable capacitance range of a variable capacitor that encompasses the range of capacitance values; determining a variable resistance range of a variable resistor that encompasses the range of resistance values; selecting a variable capacitor having said variable capacitance range for inclusion in the electronic circuit at the location of the at least one of the capacitors; and selecting a variable resistor having said variable resistance range for inclusion in the electronic circuit at the location of the at least one of the resistors.

A corresponding electronic circuit, according to the second aspect, comprising one or more capacitors, one or more resistors, and one or more additional components is also provided. At least one of the capacitors of the electronic circuit is a variable capacitor having a variable capacitance range. The variable capacitance range is determined by estimating a range of capacitance values for at least one of the capacitors in order for the electronic circuit to meet one or more desired operating parameters, and determining a variable capacitance range of the variable capacitor that encompasses the range of capacitance values. At least one of the resistors is a variable resistor having a variable resistance range determined by estimating a range of resistance values for at least one of the resistors in order for the electronic circuit to meet one or more desired operating parameters, and determining a variable resistance range of the variable resistor that encompasses the range of resistance values.

A radio frequency module and wireless device comprising such an electronic circuit according to the second aspect are also provided.

According to a number of embodiments of a third aspect, the invention provides a method for designing an electronic circuit, such as an amplifier circuit or a low-noise amplifier (LNA) circuit. The method for designing an electronic circuit comprises providing a prototype electronic circuit comprising one or more capacitors, one or more inductors, and one or more other components, at least one of the one or more capacitors being a variable capacitor and at least one of the one or more inductors being a variable inductor; testing the electronic circuit by adjusting the capacitance of the variable capacitors to determine one or more first values of the variable capacitors that cause the electronic circuit to have one or more operating parameters that meet one or more desired operating parameters of the electronic circuit; testing the electronic circuit by adjusting the inductance of the variable inductors to determine one or more first values of the variable inductors that cause the electronic circuit to have one or more operating parameters that meet one or more desired operating parameters of the electronic circuit; determining, based on the testing of the electronic circuit, capacitance values for one or more fixed-value capacitors to replace the one or more variable capacitors in the electronic circuit, each of the fixed-value capacitors having a second capacitance value equivalent to the first value of the corresponding variable capacitor; and determining, based on the testing of the electronic circuit, inductance values for one or more fixed-value inductors to replace the one or more variable inductors in the electronic circuit, each of the fixed-value inductors having a second inductance value equivalent to the first value of the corresponding variable inductor.

A method for designing the said prototype electronic circuit according to the third aspect is also provided. The method for designing a prototype electronic circuit comprises: estimating a range of capacitance values for at least one of the capacitors in order for the electronic circuit to meet one or more desired operating parameters; estimating a range of inductance values for at least one of the inductors in order for the electronic circuit to meet one or more desired operating parameters; determining a variable capacitance range of a variable capacitor that encompasses the range of capacitance values; determining a variable inductance range of a variable inductor that encompasses the range of inductance values; selecting a variable capacitor having said variable capacitance range for inclusion in the electronic circuit at the location of the at least one of the capacitors; and selecting a variable inductor having said variable inductance range for inclusion in the electronic circuit at the location of the at least one of the inductors.

A corresponding electronic circuit, according to the third aspect, comprising one or more capacitors, one or more inductors, and one or more additional components is also provided. At least one of the capacitors of the electronic circuit is a variable capacitor having a variable capacitance range. The variable capacitance range is determined by estimating a range of capacitance values for at least one of the capacitors in order for the electronic circuit to meet one or more desired operating parameters, and determining a variable capacitance range of the variable capacitor that encompasses the range of capacitance values. At least one of the inductors is a variable inductor having a variable inductance range determined by estimating a range of inductance values for at least one of the inductors in order for the electronic circuit to meet one or more desired operating parameters, and determining a variable inductance range of the variable inductor that encompasses the range of inductance values.

A radio frequency module and wireless device comprising such an electronic circuit according to the third aspect are also provided.

Recent advances in various computer-aided design (CAD), simulation, and modeling tools have enabled prediction of various parameters of complex electronic circuits with reasonable accuracy based on factors such as circuit configuration, dimensions and values of the components, and distance between the components. Similarly, such tools may also be used to predict, with reasonable accuracy, values of circuit components that are likely to lead to one or more desired circuit parameters. For example, such tools may be used to predict input and output impedances by accounting for the impedance sources. This can be particularly useful for amplifier circuits given that amplification of electronic signals typically requires several stages of amplification as gain produced by a single amplifier is often insufficient. Such multi-stage amplification involves feeding an output of one amplifier into an input of another amplifier, for which impedance matching of inputs and outputs is necessary.

Despite the recent advances in CAD, simulation, and modeling tools, achieving first-time-correct circuit designs solely by relying on CAD, simulation, and/or modelling tool(s) can be difficult even with exceptional care and attention to detail. This is at least partly because there may be factors unknown at the time of performing computer-aided design, simulation and/or modelling, such as unknown impedance sources. Therefore, when it is necessary to deliver a final design of an electronic circuit within a short timeframe, a plurality of variants of prototype circuits with one or more components having different values and/or different circuit configurations may be fabricated at the same time in order to accommodate the effects of unknown factors. This can potentially decrease the number of prototype test and/or re-design iterations required for determining a final design of an electronic circuit. However, the potential advantage of reducing the number of iterations can only be achieved if at least one of the initial variants of prototype circuits has parameters that are sufficiently close to desired values. Fabricating a high number of initial variants of prototype circuits as well as improving the accuracy of computer-aided design, simulation and/or modelling can increase the chance for the initial variants of prototype circuits to have satisfactory parameters. Nevertheless, doing so can significantly increase the total cost of circuit design process.

A method for designing an electronic circuit with reduced number of iterations, or preferably with a single iteration, of prototype circuit fabrication, test and/or re-design may be provided by using a prototype electronic circuit comprising at least one variable-value component. In particular, if one or more parameters and/or one or more properties of the electronic circuit is/are capacitance-dependent, the designing of the electronic circuit may be performed by determining desired capacitance value(s) of at least a part of the electronic circuit by using a prototype electronic circuit comprising at least one variable capacitor.

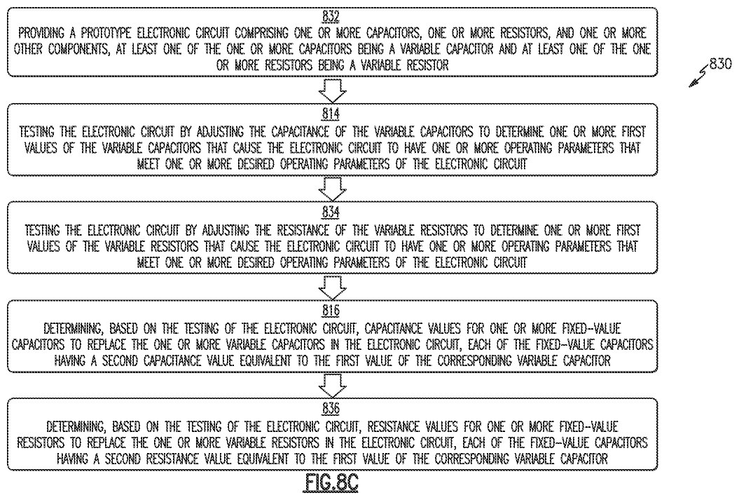

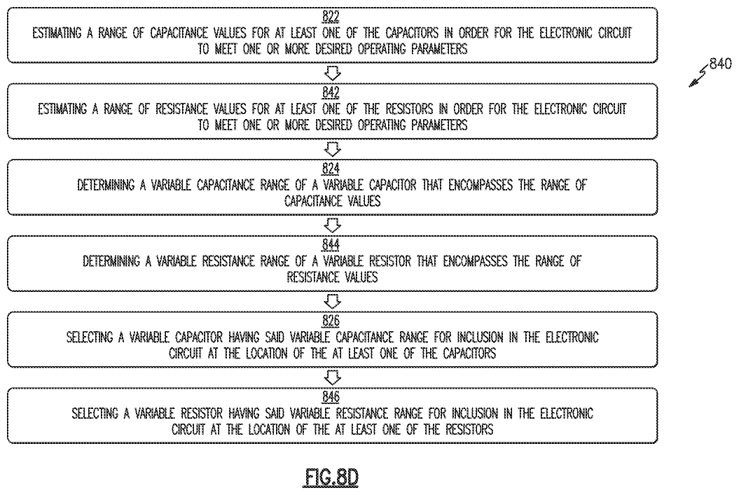

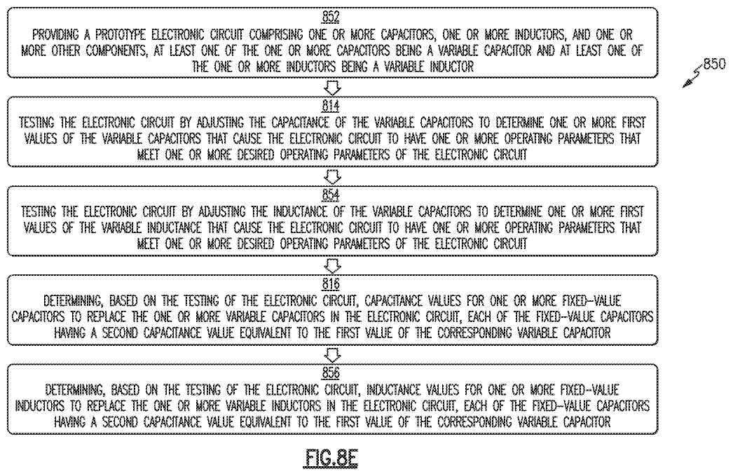

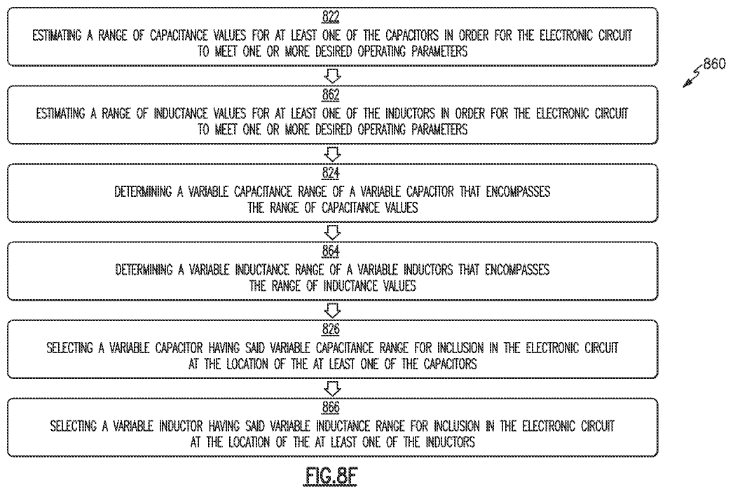

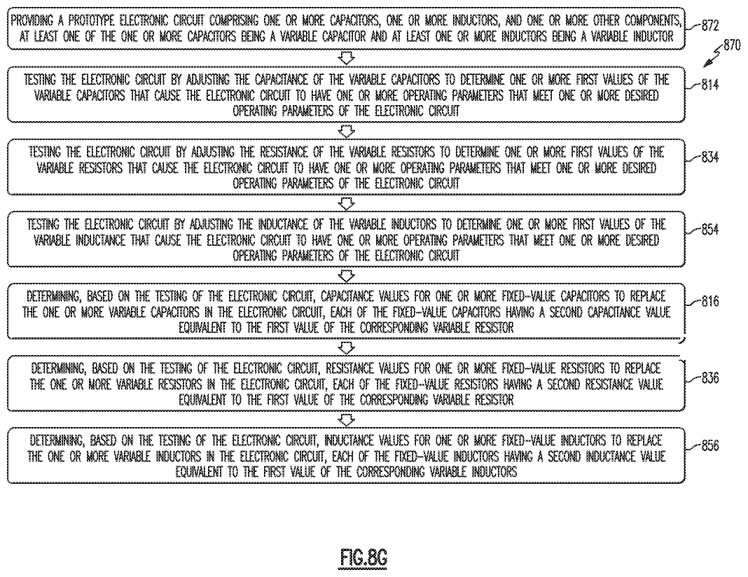

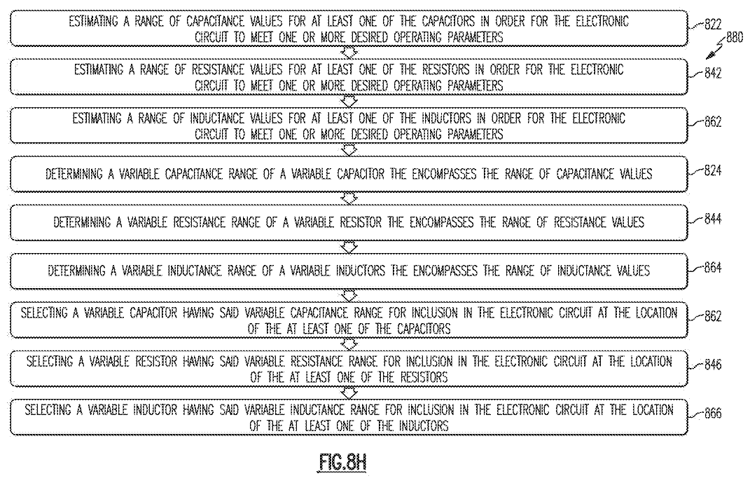

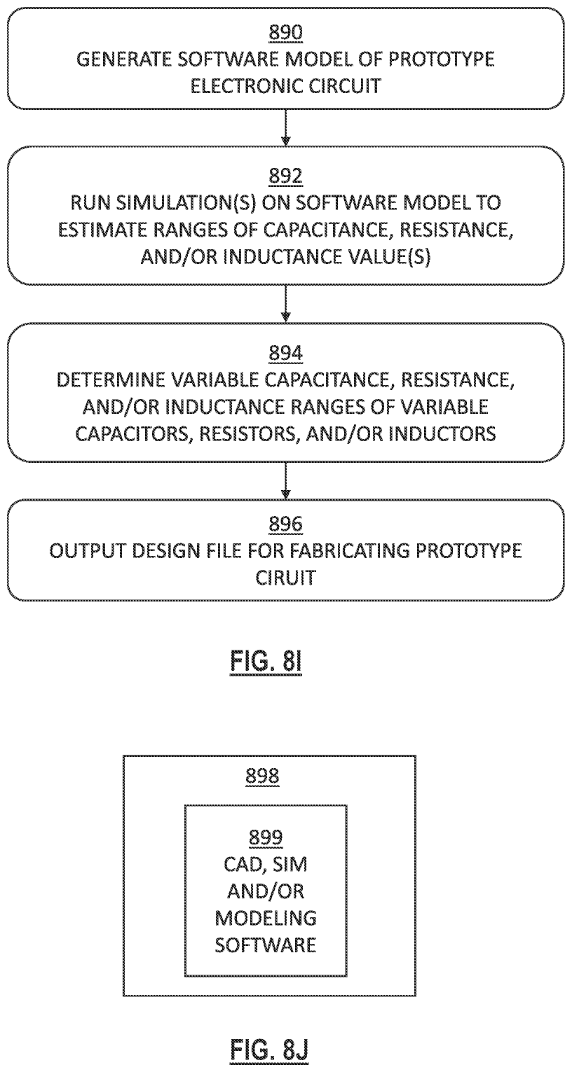

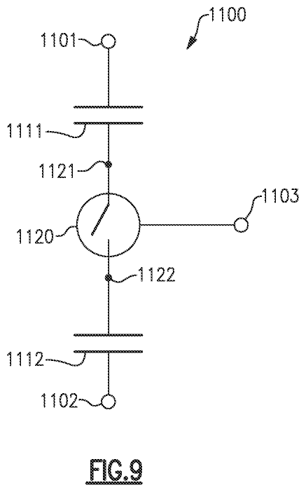

FIG. 8A is a process flow diagram (810) showing exemplary steps for designing an electronic circuit according to a number of embodiments of the first aspect of the present invention having one or more operating parameters and/or one or more properties that is/are capacitance-dependent. The steps for designing the electronic circuit, as shown in FIG. 8A, comprise a step (812) for providing a prototype electronic circuit. The prototype electronic circuit comprises one or more capacitors. Alternatively, the prototype electronic circuit comprises one or more parts and/or one or more components comprising an internal capacitance or a structure that can function as a capacitor, which may also be expressed as “capacitor(s)” for the purpose of the following discussion. At least one of the capacitors within the prototype electronic circuit is a variable capacitor. The prototype electronic circuit may also comprise one or more other non-capacitor components. The prototype electronic circuit may form a part of another electronic circuit. Alternatively, the prototype electronic circuit may be connected to one or more parts of another electronic circuit. In such cases, the prototype electronic circuit may function as a matching network, such as an impedance-matching network.

The method for designing the electronic circuit, as shown in FIG. 8A, also comprises a step (814) for testing the electronic circuit by adjusting the capacitance of the variable capacitors. In this step, the capacitance values of the variable capacitors are adjusted to determine one or more first values of the variable capacitors that cause the electronic circuit to have one or more operating parameters that meet one or more desired operating parameters of the electronic circuit.

Optionally, the conditions for meeting the desired operating parameters may be defined by a range of values, a minimum value, or a maximum value of one or more of the operating parameters. Alternatively, the conditions for meeting the desired operating parameters may be defined by a set of one or more fixed values, each of the fixed values having an error margin.

The method for designing the electronic circuit, as shown in FIG. 8A, also comprises a step (816) of determining capacitance values for one or more fixed-value capacitors to replace the one or more variable capacitors in the electronic circuit. The capacitance values of the fixed-value capacitors are determined based on the testing of the electronic circuit. As a result, each of the fixed-value capacitors will have a second capacitance value equivalent to the first value of the corresponding variable capacitor. Alternatively, each of the fixed-value capacitors may have a second capacitance value that is close to but not equal to the first value of the corresponding variable capacitor.

FIG. 8B is a process flow diagram (820) showing exemplary steps for designing the prototype electronic circuit comprising one or more capacitors and one or more other components. According to the method, a range of capacitance values for at least one of the capacitors in order for the electronic circuit to meet one or more desired operating parameters is estimated (822). The estimation of the range of the capacitance values may, for example, be performed using CAD, simulation and/or modeling. Based on the estimated range of the capacitance values, a variable capacitance range of a variable capacitor that encompasses the range of capacitance values is determined (824). Consequently, the determined variable capacitance range is used to select (826) a variable capacitor for inclusion in the electronic circuit at the location of the at least one of the capacitors.

Optionally, the operating parameter may comprise at least one frequency at which at least one part or component of the electronic circuit oscillates. In such cases, the desired operating parameters may comprise at least one desired frequency at which the at least one part or component of the electronic circuit oscillates. Optionally, the value(s) of the at least one desired frequency may be defined in a form of a minimum or a maximum frequency, or a range of frequencies. This can be useful for counteracting undesired oscillations in amplifier circuits having extended frequency response, where parasitic capacitance between the output and the input can provide a feedback path causing parasitic oscillations. Mitigating such parasitic oscillations can be particularly important in the case of high-frequency parasitic oscillations as high-frequency parasitic oscillations can generate high power that may damage other connected acoustic devices/components.

Optionally, the steps of testing (814) the electronic circuit and determining (816) capacitance values for one or more fixed-value capacitors may be performed in a way to sacrifice a first set of parameters and/or properties of the electronic circuit in favor of improving a second set of parameters and/or properties of the electronic circuit. For example, when designing a low-noise amplifier (LNA) circuit, a third order intercept point (IP3) for an output power of the circuit may be adjusted for improved linearity of the LNA by intentionally mismatching the output of an LNA.

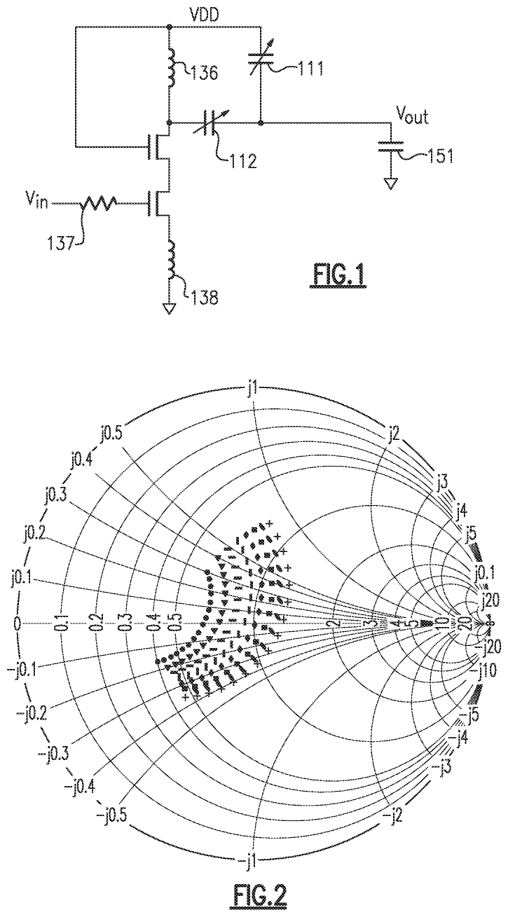

FIG. 1 shows a circuit diagram of an exemplary prototype circuit that may be used to perform the method for designing an electronic circuit according to the method of FIG. 8A. As shown in FIG. 1, the prototype electronic circuit comprises one or more capacitors (111, 112) and one or more additional components such as resistors (137) and inductors (136, 138). At least one of the capacitors (111, 112) is a variable capacitor. The prototype electronic circuit illustrated in FIG. 1 comprises one variable capacitor (111) for adjusting a shunt capacitance and one variable capacitor (112) for adjusting a series capacitance. However, the prototype electronic circuit may comprise any number of the variable capacitors and fixed-value capacitors at any suitable positions within the prototype electronic circuit. For example, in other embodiments, one or more of the capacitors (111, 112) may be fixed-value capacitors. Each of the variable capacitors may have a variable capacitance range. The variable capacitance range is determined by estimating a range of capacitance values for at least one of the capacitors in order for the electronic circuit to meet one or more desired operating parameters and determining a variable capacitance range of the variable capacitor that encompasses the range of capacitance values. Optionally, the variable capacitance range may comprise two or more tunable capacitance values. Optionally, the tunable capacitance values may be separated by regular intervals.

As shown in FIG. 1, the prototype electronic circuit may comprise one or more unexpected sources of parasitic capacitance sources (151). Although the parasitic capacitance source (151) shown in the example of FIG. 1 is located near the output port of the electronic circuit, the one or more sources of parasitic capacitance sources may exist at any position. For example, one or more sources of parasitic capacitance may exist between any two parts of the electronic circuit, between at least one part of the electronic circuit and an external device or an external component electrically connected to the at least one part of the electronic circuit, and/or between at least one part of the electronic circuit and a device or a component located adjacent to the at least one part of the electronic circuit.

Even after performing computer-aided design, modeling and/or simulation, it may not be possible to predict all sources of parasitic capacitance. As such parasitic capacitance may affect at least one of the operating parameters of the electronic circuit. It may therefore be beneficial for the prototype electronic circuit to have one or more variable capacitors to offset one or more unexpected or unknown sources of parasitic capacitance. For example, as shown in FIG. 1, the prototype electronic circuit may comprise at least one variable capacitors (111) for changing a shunt capacitance of at least one part of the electronic circuit to cause the electronic circuit to have one or more operating parameters that meet one or more desired operating parameters of the electronic circuit. As also shown in FIG. 1, the prototype electronic circuit may also comprise at least one variable capacitor (112) for changing a series capacitance of at least one part of the electronic circuit to cause the electronic circuit to have one or more operating parameters that meet one or more desired operating parameters of the electronic circuit. Similarly, the prototype electronic circuit may also comprise at least one variable capacitor to offset an internal capacitance of at least one component of the electronic circuit to cause the electronic circuit to have one or more operating parameters that meet one or more desired operating parameters of the electronic circuit.

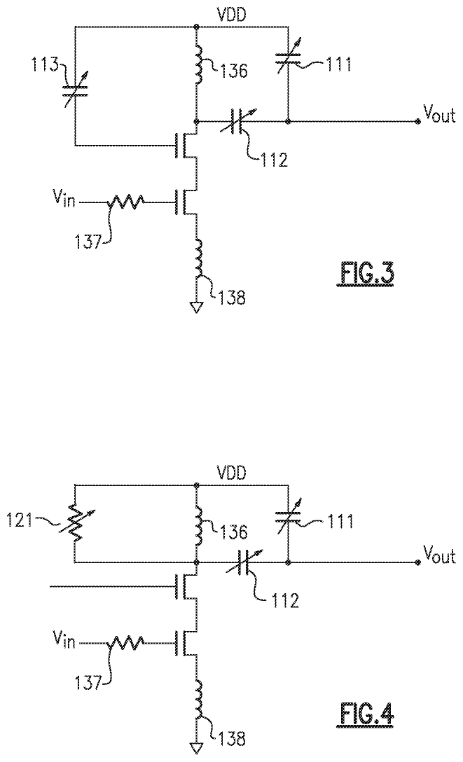

The prototype electronic circuit, having one or more variable capacitor (111,112) enables sweeping of one or more capacitance values of at least one part of the prototype electronic circuit. FIG. 2 shows a Smith Chart illustrating an example of how output return loss of the prototype electronic circuit may be impedance-matched. In the example of FIG. 2, the prototype electronic circuit comprises a first variable capacitor (111), having 16 tunable values, for changing the shunt capacitance of the prototype electronic circuit, and a second variable capacitor (112), having 8 tunable values, for changing the series capacitance of the prototype circuit. Accordingly, the Smith Chart shows 128 possible states that can be generated by adjusting the values of the first and second variable capacitors (111, 112), wherein each of the 8 symbols corresponds to one tunable series capacitor value and each of the 16 points in a same symbol corresponds to one tunable shunt capacitor value.

The possible states may be distributed in a manner that they cover the capacitance values for at least one of the capacitors that cause the electronic circuit to meet one of more desired operating parameters. For example, in FIG. 2, the 128 possible states are distributed in a manner that they cover a default point at or near 50Ω on the Smith Chart (i.e. at or near the center of the Smith Chart). The position of such a default value may, for example, be estimated using CAD, simulation and/or modeling. In cases that the electronic circuit has higher or lower parasitic capacitance value that are different from an estimated value, the default point may be shifted and may no longer be positioned at or near 50Ω on the Smith Chart. However, the possible states distributed near the default point can be used to compensate such a shift. In addition, having a plurality of possible states distributed near the default point may also be useful when a trade-off between a plurality of operating parameters, such as return loss for gain or IP3, is needed. In view of this, it will be appreciated that the prototype electronic circuit enables real-time adjustments of one or more capacitance values. Therefore, one or more operating parameters that are dependent on the capacitance values may also be measured in real-time by using a suitable measurement setup or device. This, in turn, enables the skilled person to determine optimal values of one or more capacitors of an electronic circuit and finalize the circuit design by using a single prototype electronic circuit.

Although in the example of FIG. 2 the prototype electronic circuit comprises one first variable capacitor (111) and one second variable capacitor (112) having 16 and 8 tunable values, respectively, in other embodiments, the prototype electronic circuit may comprise any suitable number of first variable capacitor(s) (111) having any suitable number of tunable values, and any suitable number of second variable capacitor(s) (112) having any suitable number of tunable values.

Optionally, at least one of the variable capacitors (111, 112) may comprise at least one capacitor (1111, 1112) and at least one switch (1120). Such configurations enable the variable capacitor(s) (111, 112) to have a plurality of tunable capacitance values. For example, in the example of FIG. 2, the first variable capacitor (111) for changing the shunt capacitance of the prototype electronic circuit may comprise 4 pairs of capacitors connected in parallel, each of the pairs of the capacitors being connected by one switch. In such a configuration, each of the 4 pairs of capacitors can be switched on and off by the switch connecting the corresponding pair, thereby providing a 4-bit variable capacitor. As each bit provides 2 switchable values, the 4-bit variable capacitor can provide up to 16 tunable capacitance values. Similarly, the second variable capacitor (112) for changing the series capacitance of the prototype electronic circuit, in the example of FIG. 2, may comprise 3 pairs of capacitors connected in parallel, each of the pairs of the capacitors being connected by one switch. Such a configuration provides a 3-bit variable capacitor that can provide up to 8 tunable capacitance values. Alternatively, for such variable capacitors, a single capacitor coupled with a switch may be used to provide each bit instead of a pair of capacitors connected by a switch. The configurations and operating principle of such variable capacitors will be discussed further with respect to FIGS. 9 to 13.

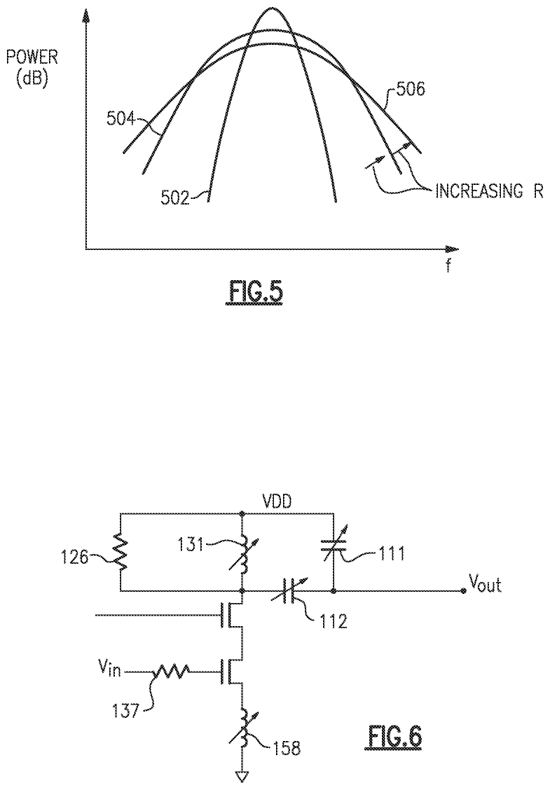

FIG. 3 shows a circuit diagram of another exemplary prototype circuit that may be used to perform the method for designing an electronic circuit according to FIG. 8A. As shown in FIG. 3, the prototype electronic circuit comprises one or more capacitors (111, 112, 113) and one or more additional components such as resistors (137) and inductors (136, 138). At least one of the capacitors (111, 112, 113) is a variable capacitor. The circuit illustrated in FIG. 3 is similar to the circuit illustrated in FIG. 1, except that the circuit illustrated in FIG. 3 comprises an additional variable capacitor (113) configured to function as a decoupling capacitor. Such a decoupling capacitor may be used to decouple a first part of the electronic circuit from a second part. For example, noise caused by one or more parts or elements of the electronic circuit may be shunted through the decoupling capacitor, reducing the effect it has on the rest of the circuit. The decoupling capacitor may also be used to bypass a power supply or other high impedance component of a circuit, and/or decouple voltage spike and/or a voltage dip from a first part of the electronic circuit from a second part of the electronic circuit.

As the degree and the performance of decoupling achieved by the decoupling capacitor may depend on the value of the decoupling capacitor, having one or more variable capacitors (113) as decoupling capacitors may be advantageous for determining the optimal value. Furthermore, as shown in FIG. 3, the prototype electronic circuit may comprise one or more variable decoupling capacitors in conjunction with other variable capacitors, such as capacitors (111, 112) for adjusting shunt and series capacitances. This can be particularly useful when one or more of the operating parameters are dependent on capacitance values of a plurality of parts of elements of the electronic circuits, and/or when a trade-off between a plurality of operating parameters is needed.

Optionally, the variable decoupling capacitor may be configured to prevent a current drawn by the first part of the electronic circuit from causing a voltage change to affect the operation of the second part of the electronic circuit. Optionally, the first and second parts of the electronic circuit may have a common power source. Optionally, the first and second parts of the electronic circuits may be coupled through a common impedance to a common power source.

Optionally, the variable decoupling capacitor may be configured to prevent radiation of electromagnetic interference between the first and second parts of the electronic circuit. This can be particularly useful where a value and/or direction of a power supply current may change, which can lead to electromagnetic interference. This may be particularly useful if the prototype circuit is configured to operate with an AC current and/or signal.

It will be appreciated that, although the prototype electronic circuit shown in FIG. 3 comprises one variable capacitor (113) configured to function as a decoupling capacitor, in other embodiments, the prototype electronic circuit may comprise any suitable number of decoupling variable capacitors (113) at any suitable positions. It will also be appreciated that, in other embodiments, all variable capacitors in the prototype electronic circuit may be configured to function as decoupling capacitors.

Optionally, at least one of the variable capacitors of the prototype electronic circuit may be configured to function as a decoupling capacitor for decoupling at least one part of the electronic circuit and an external device or an external component electrically connected to the at least one part of the electronic circuit. In such cases, at least one of the said variable capacitors may be configured to prevent a current drawn by the at least one part of the electronic circuit from causing a voltage change to affect the operation of the external device or the external component, and/or to prevent a current drawn by the external device or the external component from causing a voltage change to affect the operation of the at least one part of the electronic circuit. Optionally, at least one part of the electronic circuit and the external device or the external component may have a common power source. Optionally, the first and second parts of the electronic circuits may be coupled through a common impedance to a common power source.

Optionally, the variable decoupling capacitor may be configured to prevent radiation of electromagnetic interference between the at least one part of the electronic circuit and the external device or the external component. This can be particularly useful where a value and/or direction of a power supply current may change, which can lead to electromagnetic interference. This may be particularly useful if the prototype circuit and/or the external device or the component are configured to operate with an AC current and/or signal.

As discussed above, the variable capacitance range of each of the variable capacitors may comprise two or more tunable capacitance values that are separated by regular or irregular intervals. FIGS. 9 to 13 illustrate examples of variable capacitors that can form a part of the prototype electronic circuit for designing the electronic circuit according to any aspects and embodiments of the invention described herein.

FIG. 9 shows a circuit diagram of an example variable capacitor (1100) that includes a switch (1120) disposed between two capacitors (1111, 1112). The variable capacitor (1100) includes a first node (1101), a second node (1102), and a control node (1103). The variable capacitor (1100) has a variable capacitance between the first node (1101) and the second node (1102) that varies according to the voltage applied to the control node (1103).

The switch (1120) has a first terminal (1121) and a second terminal (1122). The impedance of the switch (1120) changes according to the voltage applied to the control node (1103) (and to a control terminal of the switch). In a closed state (in response to a first voltage applied to the control node (1103), e.g., a low voltage such as approximately 0 volts in the case of pMOS FET transistor), the switch (1120) acts as an electrical short with a parasitic resistance. In an open state (in response to a second voltage applied to the control node (1103), e.g., a high voltage such as approximately 5 volts in the case of pMOS FET transistor), the switch (1120) acts as an electrical open with a parasitic capacitance.

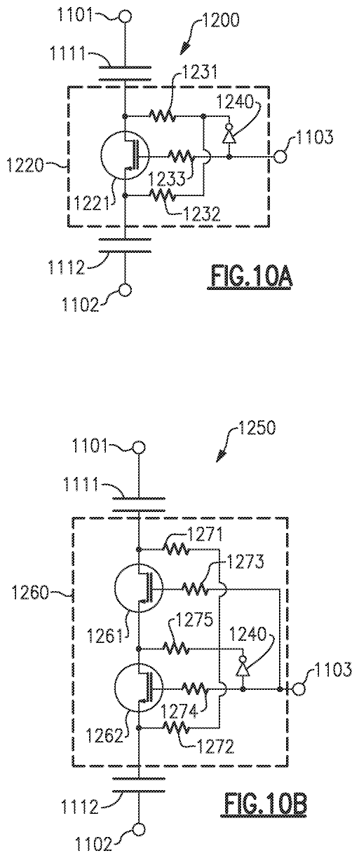

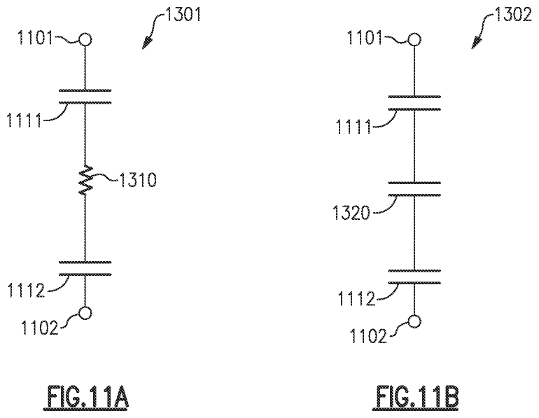

FIG. 10A shows a circuit diagram of an example variable capacitor (1200) that includes a transistor (1221) as part of a switch (1220) disposed between two capacitors (1111, 1112). The variable capacitor (1200) includes a first node (1101), a second node (1102), and a control node (1103). The variable capacitor (1200) has a variable capacitance between the first node (1101) and the second node (1102) that varies according to the voltage applied to a control node (1103).

The switch (1220) includes a transistor (1221) having a source, gate, and drain. The transistor (1221) can be, for example, an nMOS transistor. In some embodiments, the transistor (1221) can be other types of transistors, such as a BJT transistor or other types of FET transistors.

The first capacitor (1111) is disposed between the source of the transistor (1221) and the first node (1101). The second capacitor (1112) is disposed between the drain of the transistor (1221) and the second node (1102). The gate of the transistor (1221) is coupled to the control node (1103) via a resistor (1233). The resistor (1233) may be of very high resistance, e.g., 10 kΩ of more, such that, at the frequency of interest, the resistor (1233) acts as an open circuit.

The source and drain of the transistor (1221) are coupled to the control node (1103) via respective resistors (1231, 1232) and an inverter (1240). The resistors (1231, 1232) may be of a very high resistance, e.g., 10 kΩ of more, such that, at the frequency of interest, the resistor (1231, 1232) act as an open circuit. Thus, the gate and channel of the transistor (1221) are cross-biased or inverse biased. In particular, the source and drain of the transistor (1221) are each biased at opposite logic levels than the gate of the transistor (1221). The DC voltage levels at the source and drain of the transistor (1221) are isolated from circuitry coupled to the first node (1101) and second node (1102) by the first capacitor (1111) and the second capacitor (1112).

FIG. 10B shows a circuit diagram of an example variable capacitor (1250) that includes multiple transistors (1261, 1262) as part of a switch (1260) disposed between two capacitors (1111, 1112). The variable capacitor (1250) includes a first node (1101), a second node (1102), and a control node (1103). The variable capacitor (1250) has a variable capacitance between the first node (1101) and the second node (1102) that varies according to the voltage applied to a control node (1103).

The first capacitor (1111) is disposed between the source of the first transistor (1261) and the first node (1101). The second capacitor (1112) is disposed between the drain of a second transistor (1262) and the second node (1102). The gate of the each of the transistor (1261, 1262) is coupled to the control node (1103) via respective resistors (1273, 1274). The drain of the first transistor (1261) is coupled to the source of the second transistor (1262). The source and drain of each transistor (1261, 1262) are coupled to the control node (1103) via respective resistors (1271, 1272, 1275) and an inverter (1240).

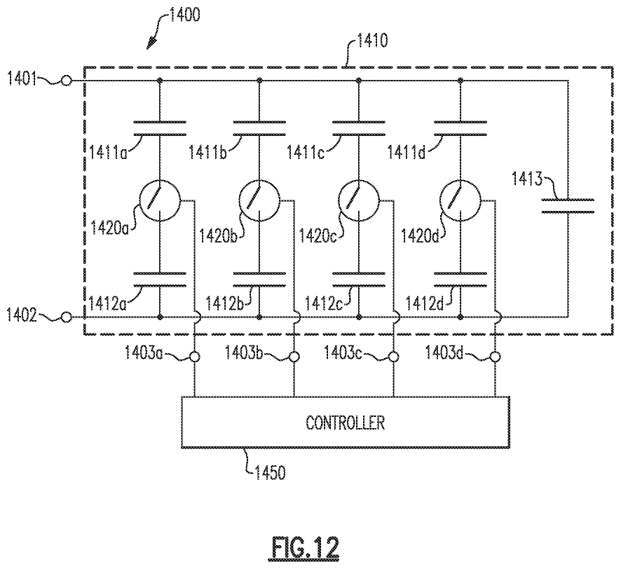

FIGS. 11A and 11B show equivalent circuit diagrams of the variable capacitor (1100) of FIG. 9 in an on state and an off state, respectively. In the on state, shown in FIG. 11A, the switch acts as a parasitic resistance (1310) and the variable capacitance of the variable capacitor (1301) is the capacitance of the first capacitor (1111) and second capacitor (1112) in series. In particular, the variable capacitance, C_{V}, is approximately equal to the inverse of the sum of the inverse of the capacitance of the first capacitor, C1, and the inverse of the capacitance of the second capacitor, C₂. Thus, C_{Von}=(1/C₁+1/C₂)⁻¹. In some embodiments, the capacitance of the first capacitor (1111) is approximately equal to the capacitance of the second capacitor (1112). Thus, C_{Von}=C₁/2.

In the off state, shown in FIG. 11B, the switch acts as a parasitic capacitance (1320) and the variable capacitance of the variable capacitor (1302) is the capacitance of the first capacitor (1111), second capacitor (1112), and parasitic capacitance (1320) in series. In particular, the variable capacitance, C_{Voff}, is approximately equal to the inverse of the sum of the inverse of the capacitance of the first capacitor, C₁, the inverse of the capacitance of the second capacitor, C₂, and the inverse of the parasitic capacitance, Cp. Thus, C_{Voff}=(1/C₁+1/C₂+1/CP)⁻¹. In some embodiments, the parasitic capacitance is caused by the capacitance between the gate and source of a transistor, C_{gs}, and the capacitance between the gate and drain of the transistor, C_{gd}. Thus, in some embodiments, C_{V}=(1/C₁+1/C₂+1/C_{gs}+1/C_{gd})⁻¹. In some embodiments, the gate-source capacitance and gate-drain capacitance are equal. Thus, in some embodiments, C_{Voff}=(1/C₁+1/C₂+2/C_{gs})⁻¹. In some embodiments, the capacitance of the first capacitor 111 is approximately equal to the capacitance of the second capacitor (1112). Thus, C_{Voff}=(2/C₁+2/C_{gs})⁻¹.

Because the parasitic capacitance is small, in some embodiments, the ratio of the maximum capacitance (CVon) to the minimum capacitance (CVoff) is six or greater. The parasitic capacitance may be smaller (and the ratio higher) in cases when multiple transistors are used in series, e.g., as in FIG. 10B.

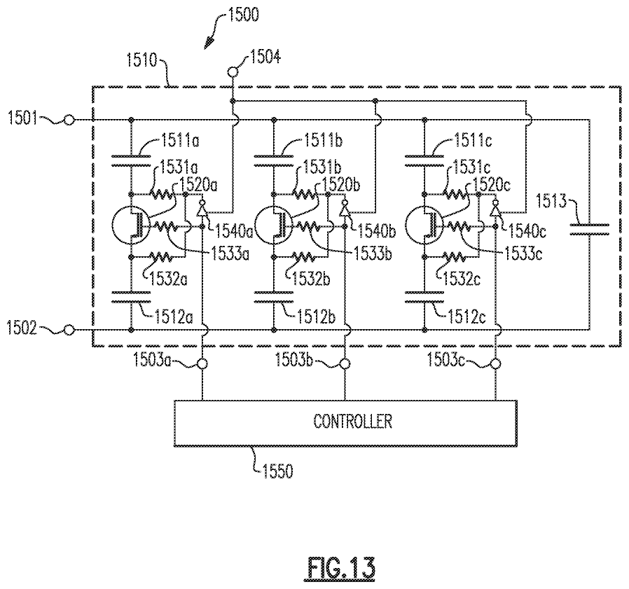

FIG. 12 shows a circuit diagram of an example variable capacitor configuration (1400) that includes multiple variable capacitance elements in parallel. The variable capacitor configuration (1400) includes a variable capacitor (1410) and a controller (1450). The variable capacitor (1410) includes a plurality of variable capacitance elements of the type shown in FIG. 9 connected in parallel. Optionally, the variable capacitor (1410) further includes an optional offset capacitor (1413) connected in parallel. In some embodiments, the variable capacitor (1410) does not include the offset capacitor (1413).

The variable capacitor (1410), which may be implemented as an integrated circuit on a single die, has a first node (1401), a second node (1402), and a plurality of control nodes (1403a-1403d). The variable capacitor (1410) has a variable capacitance between the first node (1401) and the second node (1402) that varies according to a control word applied to the control nodes (1403a-1403d) by the controller (1450).

Each of the variable capacitance elements includes a switch (1420a-1420d) disposed between a respective first capacitor (1411a-1411d) and a respective second capacitor (1412a-412d). In some implementations, the capacitance of each first capacitor (1411a-1411d) is substantially equal to the capacitance of the corresponding respective second capacitor (1412a-1412d). For example, the capacitance of first capacitor (1411a) is substantially equal to the capacitance of second capacitor (1412a). In some implementations, the capacitance of each first capacitor (1411a-1411d) is not equal to the capacitance of the corresponding respective second capacitor (1412a-1412d). In some implementations, a respective first capacitor (e.g., 1411b) of a parallel branch of the variable capacitor (1410) is substantially equal to the capacitance of a corresponding respective second capacitor (e.g., 1412b), but is not equal to the capacitance of another first capacitor (e.g., 1411c) of variable capacitor (1410). In other words, in some implementations, the variable capacitance of a respective parallel branch differs from the variable capacitance of another parallel branch of the variable capacitor (1410).

The maximum capacitance of the variable capacitor (1410), denoted Cₘₐₓ, may be many times the minimum capacitance of the variable capacitor (1410), denoted Cₘᵢₙ. For example, the maximum capacitance may be at least six times the minimum capacitance. The minimum capacitance can be increased (and the ratio of the maximum capacitance to the minimum capacitance decreased) by increasing the capacitance of the offset capacitor (1413).

The maximum capacitance of the variable capacitor (1410) is approximately equal to the sum of the maximum capacitances of the variable capacitance elements, denoted Cₒₙ₋ₐ through C_{on-d}, and the capacitance of the offset capacitor (1413), denoted C_{offset}. Thus, Cₘₐₓ=Cₒₙ₋ₐ+C_{on-b}+C_{on-c}+C_{on-d}+C_{offset}. Similarly, the minimum capacitance of the variable capacitor (1410) is approximately equal to the sum of the minimum capacitances of the variable capacitance elements, denoted C_{off-a} through C_{off-d}, and the capacitance of the offset capacitor (1413). Thus, Cₘᵢₙ=C_{off-a}+C_{off-b}+C_{off-c}+C_{off-a}+C_{offset}. The capacitance of the variable capacitor (1410) can changed to various values between Cₘᵢₙ and Cₘₐₓ by turning on or off various variable capacitance elements. For example, the capacitance of the variable capacitor (1410) can be set to C_{off-a}+C_{on-b}+C_{on-c}+C_{off-d}+C_{offset} by turning off the first and final variable capacitance elements and turning on the middle variable capacitance elements. In general,

C=Cₘᵢₙ+Σₙaₙ(Cₒₙ₋ₙ−C_{off-n})=Cₘᵢₙ+ΣₙaₙΔCₙk,

wherein aₙ represents the bits of the control word. By selecting ΔCₙ for each variable capacitance element to be twice that of the previous variable capacitance element in a binary fashion, the capacitance of the variable capacitor (1410) can be a substantially linear function of the control word.

FIG. 12 illustrates the implementation of four parallel capacitance branches in variable transistor (1410), however any number of parallel branches can be implemented in a variable capacitor as described in this disclosure.

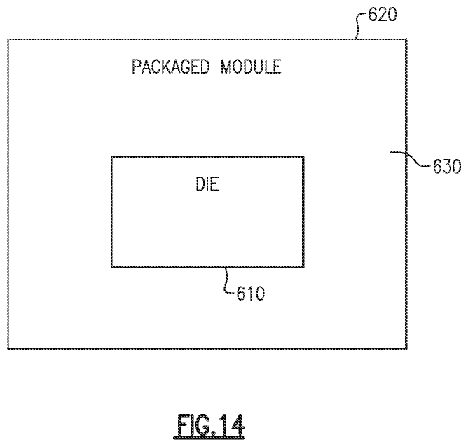

FIG. 13 shows a circuit diagram of an example variable capacitor configuration (1500) that includes multiple variable capacitance elements in parallel including transistors. The variable capacitor configuration (1500) includes a variable capacitor (1510) and a controller (1550). The variable capacitor (1510) includes a plurality of variable capacitance elements of the type shown in FIG. 10A connected in parallel. In some embodiments, the variable capacitor (1510) further includes an optional offset capacitor (1513) connected in parallel. In some embodiments, optional offset capacitor (1513) provides a minimum capacitance value for variable capacitor (1510). For example, a particular circuit may require a minimum capacitance value higher than the capacitance derived from the parallel variable capacitance elements.

The variable capacitor (1510), which may be implemented as an integrated circuit on a single die, has a first node (1501), a second node (1502), a plurality of control nodes (1503a-1503c), and a supply node (1504) for receiving a supply voltage that powers the inverters 1540a-1540c. The variable capacitor 1510 has a variable capacitance between the first node 1501 and the second node 1502 that varies according to the control word applied to the control nodes 1503a-1503c by the controller 1550.

Each of the variable capacitance elements includes a transistor (1520a-1520c) disposed between a respective first capacitor (1511a-1511c) and a respective second capacitor (1512a-1512c). In particular, each first capacitor (1511a-1511c) is disposed between the first node (1501) and the source of a respective transistor (1520a-1520c) and each second capacitor (1512a-1512c) is disposed between the second node (1502) and the drain of the respective transistor (1520a-1520c). Each control node (1503a-1503c) is coupled to the gate of a respective transistor (1520a-1520c) via a resistor (1533a-1533c) and to the source and drain of the respective transistor (1520a-1520c) via a respective inverter (1540a-1540c) and resistors (1531a-1531c, 1532a-1532c).

In some implementations, the capacitance of each first capacitor (1511a-1511d) is substantially equal to the capacitance of the corresponding respective second capacitor (1512a-1512d). For example, the capacitance of first capacitor (1511a) is substantially equal to the capacitance of second capacitor (1512a). In some implementations, the capacitance of each first capacitor (1511a-1511d) is not equal to the capacitance of the corresponding respective second capacitor (1512a-1512d). In some implementations, a respective first capacitor (e.g., 1511b) of a parallel branch of the variable capacitor (1510) is substantially equal to the capacitance of a corresponding respective second capacitor (e.g., 1512b), but is not equal to the capacitance of another first capacitor (e.g., 1511c) of variable capacitor (1510). In other words, in some implementations, the variable capacitance of a respective parallel branch differs from the variable capacitance of another parallel branch of the variable capacitor (1510).

FIG. 13 illustrates the implementation of three parallel capacitance branches in variable transistor (1510), however any number of parallel branches can be implemented in a variable capacitor as described in this disclosure.

Various electronic circuits may also have one or more operating parameters that are capacitance-dependent and/or resistance-dependent. For such cases, a method for designing an electronic circuit with reduced number of iterations, or preferably with a single iteration, of prototype circuit fabrication, test and/or re-design may be provided by using a prototype electronic circuit comprising at least one variable-value capacitor and at least one variable-value resistor.

FIG. 8C is a process flow diagram (830) showing exemplary steps for designing an electronic circuit according to a number of embodiments of the second aspect of the present invention having one or more operating parameters and/or one or more properties that is/are capacitance-dependent, and one or more operating parameters and/or one or more properties that is/are resistance-dependent. The steps for designing the electronic circuit, as shown in FIG. 8C, comprises a step (832) for providing a prototype electronic circuit. The prototype electronic circuit comprises one or more capacitors and one or more resistors. Alternatively, the prototype electronic circuit comprises: one or more parts and/or one or more components comprising an internal capacitance or a structure that can function as a capacitor, which may also be expressed as “capacitor(s)” for the purpose of the following discussion; and one or more parts and/or one or more components comprising an internal resistance or a structure that can function as a resistor, which may also be expressed as “resistor(s)” for the purpose of the following discussion. At least one of the capacitors within the prototype electronic circuit is a variable capacitor, and at least one of the resistors within the prototype electronic circuit is a variable resistor. The prototype electronic circuit may also comprise one or more other components that are not capacitors or resistors. The prototype electronic circuit may form a part of another electronic circuit. Alternatively, the prototype electronic circuit may be connected to one or more parts of another electronic circuit. In such cases, the prototype electronic circuit may function as a matching network, such as an impedance-matching network.

The method for designing the electronic circuit, as shown in FIG. 8C, also comprises a step (814) for testing the electronic circuit by adjusting the capacitance of the variable capacitors. In this step, the capacitance values of the variable capacitors are adjusted to determine one or more first values of the variable capacitors that cause the electronic circuit to have one or more operating parameters that meet one or more desired operating parameters of the electronic circuit.

The method for designing the electronic circuit, as shown in FIG. 8C, also comprises a step (834) for testing the electronic circuit by adjusting the resistance of the variable resistors. In this step, the resistance values of the variable resistors are adjusted to determine one or more first values of the variable resistors that cause the electronic circuit to have one or more operating parameters that meet one or more desired operating parameters of the electronic circuit.

Optionally, the conditions for meeting the desired operating parameters may be defined by a range of values, a minimum value, or a maximum value of one or more of the operating parameters. Alternatively, the conditions for meeting the desired operating parameters may be defined by a set of one or more fixed values, each of the fixed values having an error margin.

The method for designing the electronic circuit, as shown in FIG. 8C, also comprises a step (816) of determining capacitance values for one or more fixed-value capacitors to replace the one or more variable capacitors in the electronic circuit. The capacitance values of the fixed-value capacitors are determined based on the testing of the electronic circuit. As a result, each of the fixed-value capacitors will have a second capacitance value equivalent to the first value of the corresponding variable capacitor. It will be appreciated that, in practice, each of the fixed-value capacitors may have a second capacitance value that is close to but not equal to the first value of the corresponding variable capacitor.

The method for designing the electronic circuit, as shown in FIG. 8C, also comprises a step (836) of determining resistance values for one or more fixed-value resistors to replace the one or more variable resistors in the electronic circuit. The resistance values of the fixed-value resistors are determined based on the testing of the electronic circuit. As a result, each of the fixed-value resistors will have a second resistance value equivalent to the first value of the corresponding variable resistor. Alternatively, each of the fixed-value resistors may have a second resistance value that is close to but not equal to the first value of the corresponding variable resistor.

FIG. 8D is a process flow diagram (840) showing exemplary steps for designing the prototype electronic circuit comprising one or more capacitors, one or more resistors and one or more other components. According to the method, a range of capacitance values for at least one of the capacitors in order for the electronic circuit to meet one or more desired operating parameters is estimated (822). According to the method, a range of resistance values for at least one of the resistors in order for the electronic circuit to meet one or more desired operating parameters is also estimated (842). The estimations of the ranges of the capacitance and resistance values may, for example, be performed using CAD, simulation and/or modeling. Based on the estimated range of the capacitance values, a variable capacitance range of a variable capacitor that encompasses the range of capacitance values is determined (824). Based on the estimated range of the resistance values, a variable resistance range of a variable resistor that encompasses the range of resistance values is determined (844). Consequently, the determined variable capacitance range is used to select (826) a variable capacitor for inclusion in the electronic circuit at the location of the at least one of the capacitors, and the determined variable resistance range is used to select (846) a variable resistor for inclusion in the electronic circuit at the location of the at least one of the resistors.

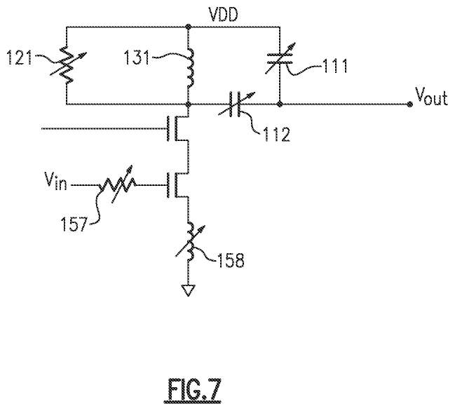

FIG. 4 shows a circuit diagram of an exemplary prototype circuit that may be used to perform the method for designing an electronic circuit according to FIG. 8C. As shown in FIG. 4, the prototype electronic circuit comprises one or more capacitors (111, 112), one or more resistors (121, 137), and one or more additional components such as one or more inductors (138). At least one of the capacitors (111, 112) is a variable capacitor, and at least one of the resistors (121, 137) is a variable resistor.

Having a high quality factor (Q factor) is desirable in many electronic circuits and applications. However, there may be contrary cases in which a low Q factor is preferred, or there is a need for a trade-off between a Q factor and one or more operating parameters of the electronic circuits. For example, lowering a Q factor may broaden frequency responses of one or more operating parameters, which may be particularly useful for wide-band applications. A Q factor of the prototype electronic circuit may be adjusted by controlling one or more of the variable resistors (121) of the prototype electronic circuit. FIG. 5 illustrates an exemplary power-frequency graph of the prototype electronic circuit according to FIG. 4. As shown in FIG. 5, the power gain of the prototype electronic circuit has a higher Q factor when the resistance of the variable resistor (121) is low (502). Although having a high Q factor typically leads to a higher peak power gain, it often leads to a narrow frequency response, which may be problematic for applications requiring a wider frequency response, such as wide-band RF devices. In such cases, the variable resistor (121) may be adjusted to have a higher value (504, 506) that meets the frequency response profile of the wide-band devices. Furthermore, as such adjustments and monitoring of relevant circuit operating parameters can be performed in real-time, increasing the resistance value to an excessively high value that can cause undesired effects, such as insufficient power gain, can be easily avoided. Conversely, for applications requiring a narrow frequency response and/or high gain, the prototype electronic circuit may also be used to determine an optimal resistance value that can lead to a high Q factor. It will be appreciated that, although the current example discussed in relation to FIG. 4 and FIG. 5 relates to optimizing the power gain over the frequency of interest, the same principle may be applied for optimizing any other types of operating parameters. It will also be appreciated that the resistance values of one or more of the variable resistors (121) may be adjusted in conjunction with the capacitance values of the variable capacitors (111, 112) to determine optimal values of the corresponding resistors and capacitors.

Optionally, prior to at least one of the steps of testing (814, 834) the electronic circuit, at least one of the variable resistors may have a high initial resistance value. This can be useful for minimizing the initial impact of the at least one of the variable resistors on at least one of the operating parameters of the electronic circuit. For example, at least one of the variable resistors may have an initial resistance value greater than 20 kΩ prior to the steps of testing (814, 834) the electronic circuit, and the resistance of the at least one of the variable resistors may be adjusted by decreasing the resistance value from the high initial resistance value. This can be particularly useful where initiating the steps of testing (814, 834) the electronic circuit with a low resistance value can undesirably increase the current through the corresponding variable resistor, which in turn may also affect the function of other components of the electronic circuit. For example, in the cases where the corresponding resistor is connected in parallel with an inductor and/or a capacitor, starting the steps of testing (814, 834) with a low resistance value may excessively decrease the current through the connected inductor and/or capacitor, thereby nullifying their functions in the electronic circuit.

Alternatively, prior to at least one of the steps of testing (814, 834) the electronic circuit, at least one of the variable resistors may optionally have a low initial resistance value. This can be useful for minimizing the initial impact of the at least one of the variable resistors on at least one of the operating parameters of the electronic circuit. For example, at least one of the variable resistors may have an initial resistance value smaller than 1Ω prior to the steps of testing (814, 834) the electronic circuit, and the resistance of the at least one of the variable resistors may be adjusted by increasing the resistance value from the low initial resistance value. This can be particularly useful where initiating the steps of testing (814, 834) the electronic circuit with a high resistance value can undesirably limit the current through the corresponding variable resistor, which in turn may also affect the function of other components of the electronic circuit. For example, in the cases where the corresponding resistor is connected in series with an inductor and/or a capacitor, starting the steps of testing (814, 834) with a high resistance value may excessively limit the current through the connected inductor and/or capacitor, thereby nullifying their functions in the electronic circuit.

Optionally, the variable resistors and/or variable capacitors may be digitally programmable. In addition, the values of the variable resistors and/or variable capacitors may be controlled by one or more controllers. Optionally, a plurality of the variable resistors and/or variable capacitors may be controlled by one controller.

Various electronic circuits may also have one or more operating parameters that are capacitance-dependent and/or inductance-dependent. For such cases, a method for designing an electronic circuit with reduced number of iterations, or preferably with a single iteration, of prototype circuit fabrication, test and/or re-design may be provided by using a prototype electronic circuit comprising at least one variable-value capacitor and at least one variable-value inductor.

FIG. 8E is a process flow diagram (850) showing exemplary steps for designing an electronic circuit according to a number of embodiments of the third aspect of the present invention having one or more operating parameters and/or one or more properties that is/are capacitance-dependent, and one or more operating parameters and/or one or more properties that is/are inductance-dependent. The steps for designing the electronic circuit, as shown in FIG. 8E, comprises a step (852) for providing a prototype electronic circuit. The prototype electronic circuit comprises one or more capacitors and one or more inductors. Alternatively, the prototype electronic circuit comprises: one or more parts and/or one or more components comprising an internal capacitance or a structure that can function as a capacitor, which may also be expressed as “capacitor(s)” for the purpose of the following discussion; and one or more parts and/or one or more components comprising an internal inductance or a structure that can function as a inductor, which may also be expressed as “inductor(s)” for the purpose of the following discussion. At least one of the capacitors within the prototype electronic circuit is a variable capacitor, and at least one of the inductors within the prototype electronic circuit is a variable inductor. The prototype electronic circuit may also comprise one or more other components that are not capacitors or inductors. The prototype electronic circuit may form a part of another electronic circuit. Alternatively, the prototype electronic circuit may be connected to one or more parts of another electronic circuit. In such cases, the prototype electronic circuit may function as a matching network, such as an impedance-matching network.

The method for designing the electronic circuit, as shown in FIG. 8E, also comprises a step (814) for testing the electronic circuit by adjusting the capacitance of the variable capacitors. In this step, the capacitance values of the variable capacitors are adjusted to determine one or more first values of the variable capacitors that cause the electronic circuit to have one or more operating parameters that meet one or more desired operating parameters of the electronic circuit.

The method for designing the electronic circuit, as shown in FIG. 8E, also comprises a step (854) for testing the electronic circuit by adjusting the inductance of the variable inductors. In this step, the inductance values of the variable inductors are adjusted to determine one or more first values of the variable inductors that cause the electronic circuit to have one or more operating parameters that meet one or more desired operating parameters of the electronic circuit.

Optionally, the conditions for meeting the desired operating parameters may be defined by a range of values, a minimum value, or a maximum value of one or more of the operating parameters. Alternatively, the conditions for meeting the desired operating parameters may be defined by a set of one or more fixed values, each of the fixed values having an error margin.

The method for designing the electronic circuit, as shown in FIG. 8E, also comprises a step (816) of determining capacitance values for one or more fixed-value capacitors to replace the one or more variable capacitors in the electronic circuit. The capacitance values of the fixed-value capacitors are determined based on the testing of the electronic circuit. As a result, each of the fixed-value capacitors will have a second capacitance value equivalent to the first value of the corresponding variable capacitor. Each of the fixed-value capacitors may, in practice, have a second capacitance value that is close to but not equal to the first value of the corresponding variable capacitor.

The method for designing the electronic circuit, as shown in FIG. 8E, also comprises a step (856) of determining inductance values for one or more fixed-value inductors to replace the one or more variable inductors in the electronic circuit. The inductance values of the fixed-value inductors are determined based on the testing of the electronic circuit. As a result, each of the fixed-value inductors will have a second inductance value equivalent to the first value of the corresponding variable inductor. Each of the fixed-value inductors may, in practice, have a second inductance value that is close to but not equal to the first value of the corresponding variable inductor.

FIG. 8F is a process flow diagram (860) showing exemplary steps for designing the prototype electronic circuit comprising one or more capacitors, one or more inductors and one or more other components. According to the method, a range of capacitance values for at least one of the capacitors in order for the electronic circuit to meet one or more desired operating parameters is estimated (822). According to the method, a range of inductance values for at least one of the inductors in order for the electronic circuit to meet one or more desired operating parameters is also estimated (862). The estimations of the ranges of the capacitance and inductance values may, for example, be performed using CAD, simulation and/or modeling. Based on the estimated range of the capacitance values, a variable capacitance range of a variable capacitor that encompasses the range of capacitance values is determined (824). Based on the estimated range of the inductance values, a variable inductance range of a variable inductor that encompasses the range of inductance values is determined (864). Consequently, the determined variable capacitance range is used to select (826) a variable capacitor for inclusion in the electronic circuit at the location of the at least one of the capacitors, and the determined variable inductance range is used to select (866) a variable inductor for inclusion in the electronic circuit at the location of the at least one of the inductors.

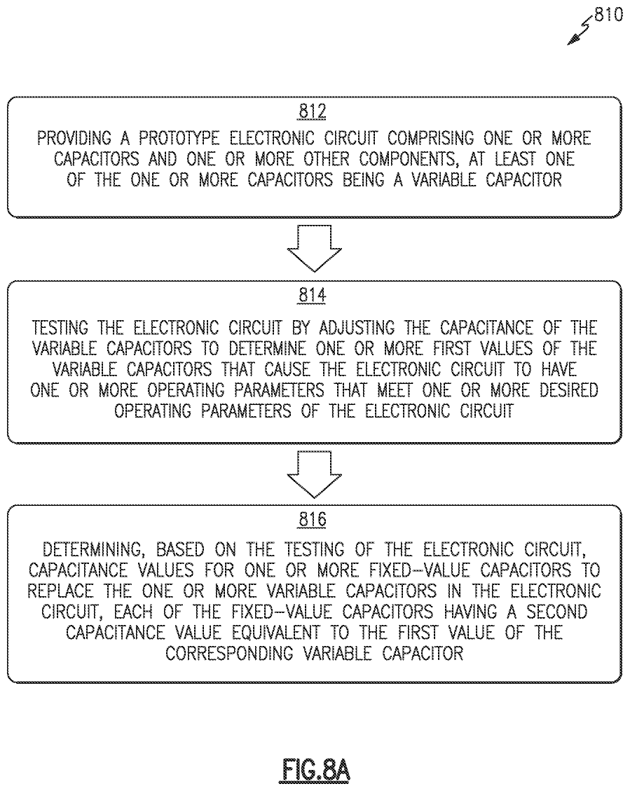

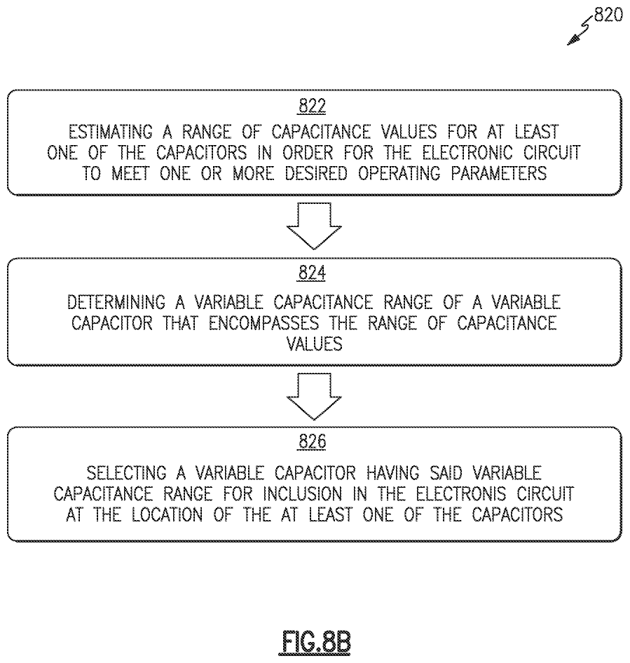

FIG. 6 shows a circuit diagram of an exemplary prototype circuit that may be used to perform the method for designing an electronic circuit according to FIG. 8E. As shown in FIG. 6, the prototype electronic circuit comprises one or more capacitors (111, 112), one or more inductors (131, 158), and one or more additional components such as one or more resistors (126, 137). At least one of the capacitors (111, 112) is a variable capacitor, and at least one of the inductors (131, 158) is a variable inductor. Such configurations of the prototype electronic circuit enable real-time adjustments of one or more inductance and/or capacitance values. Therefore, by monitoring circuit operating parameters that are dependent on the inductance and/or capacitance values, optimal values of the corresponding inductors and/or capacitors can be determined.

Optionally, prior to at least one of the steps of testing (814, 834) the electronic circuit, at least one of the variable inductors may have a high initial inductance value. In such cases, the inductance of the at least one of the variable inductors may be adjusted by decreasing the inductance value from the high initial inductance value. This can be useful where a high inductance value can minimize the initial impact on at least one of the operating parameters of the electronic circuit. Alternatively, prior to at least one of the steps of testing (814, 834) the electronic circuit, at least one of the variable inductors may optionally have a low initial inductance value. In such cases, the inductance of the at least one of the variable inductors may be adjusted by increasing the inductance value from the low initial inductance value. This can be useful where a low inductance value can minimize the initial impact on at least one of the operating parameters of the electronic circuit.

Optionally, the variable inductor and/or variable capacitors may be digitally programmable. In addition, the values of the variable inductor and/or variable capacitors may be controlled by one or more controllers. Optionally, a plurality of the variable inductors and/or variable capacitors may be controlled by one controller.

Various electronic circuits may also have one or more operating parameters that are capacitance-dependent, resistance-dependent, and/or inductance-dependent. Therefore, some embodiments may incorporate any suitable combination of features and advantages from two or more of the first, second and their aspect of the present invention. For example, a method for designing an electronic circuit with reduced number of iterations, or preferably with a single iteration, of prototype circuit fabrication, test and/or re-design may be provided by using a prototype electronic circuit comprising at least one variable-value capacitor, at least one variable value resistor, and at least one variable inductor.

FIG. 8G is a process flow diagram (870) showing exemplary steps for designing an electronic circuit having one or more operating parameters and/or one or more properties that is/are capacitance-dependent, one or more operating parameters and/or one or more properties that is/are resistance-dependent, and one or more operating parameters and/or one or more properties that is/are resistance-dependent. The steps for designing the electronic circuit, as shown in FIG. 8G, comprises a step (872) for providing a prototype electronic circuit. The prototype electronic circuit comprises one or more capacitors, one or more resistors, and one or more inductors. Alternatively, the prototype electronic circuit comprises: one or more parts and/or one or more components comprising an internal capacitance or a structure that can function as a capacitor, which may also be expressed as “capacitor(s)” for the purpose of the following discussion; one or more parts and/or one or more components comprising an internal resistance or a structure that can function as a resistor, which may also be expressed as “resistor(s)” for the purpose of the following discussion; and one or more parts and/or one or more components comprising an internal inductance or a structure that can function as a inductor, which may also be expressed as “inductor(s)” for the purpose of the following discussion. At least one of the capacitors within the prototype electronic circuit is a variable capacitor, at least one of the resistors within the prototype electronic circuit is a variable resistor, and at least one of the inductors within the prototype electronic circuit is a variable inductor. The prototype electronic circuit may also comprise one or more other components that are not capacitors resistors, or inductors. The prototype electronic circuit may form a part of another electronic circuit. Alternatively, the prototype electronic circuit may be connected to one or more parts of another electronic circuit. In such cases, the prototype electronic circuit may function as a matching network, such as an impedance-matching network.

The method for designing the electronic circuit, as shown in FIG. 8G, also comprises a step (814) for testing the electronic circuit by adjusting the capacitance of the variable capacitors. In this step, the capacitance values of the variable capacitors are adjusted to determine one or more first values of the variable capacitors that cause the electronic circuit to have one or more operating parameters that meet one or more desired operating parameters of the electronic circuit.

The method for designing the electronic circuit, as shown in FIG. 8G, also comprises a step (834) for testing the electronic circuit by adjusting the resistance of the variable resistors. In this step, the resistance values of the variable resistors are adjusted to determine one or more first values of the variable resistors that cause the electronic circuit to have one or more operating parameters that meet one or more desired operating parameters of the electronic circuit.

The method for designing the electronic circuit, as shown in FIG. 8G, also comprises a step (854) for testing the electronic circuit by adjusting the inductance of the variable inductors. In this step, the inductance values of the variable inductors are adjusted to determine one or more first values of the variable inductors that cause the electronic circuit to have one or more operating parameters that meet one or more desired operating parameters of the electronic circuit.

Optionally, the conditions for meeting the desired operating parameters may be defined by a range of values, a minimum value, or a maximum value of one or more of the operating parameters. Alternatively, the conditions for meeting the desired operating parameters may be defined by a set of one or more fixed values, each of the fixed values having an error margin.

The method for designing the electronic circuit, as shown in FIG. 8G, also comprises a step (816) of determining capacitance values for one or more fixed-value capacitors to replace the one or more variable capacitors in the electronic circuit. The capacitance values of the fixed-values capacitors are determined based on the testing of the electronic circuit. As a result, each of the fixed-value capacitors will have a second capacitance value equivalent to the first value of the corresponding variable capacitor. Each of the fixed-value capacitors may, in practice, have a second capacitance value that is close to but not equal to the first value of the corresponding variable capacitor.

The method for designing the electronic circuit, as shown in FIG. 8G, also comprises a step (836) of determining resistance values for one or more fixed-value resistors to replace the one or more variable resistors in the electronic circuit. The resistance values of the fixed-values resistors are determined based on the testing of the electronic circuit. As a result, each of the fixed-value resistors will have a second resistance value equivalent to the first value of the corresponding variable resistor. Each of the fixed-value resistors may, in practice, have a second resistance value that is close to but not equal to the first value of the corresponding variable resistor.

The method for designing the electronic circuit, as shown in FIG. 8E, also comprises a step (856) of determining inductance values for one or more fixed-value inductors to replace the one or more variable inductors in the electronic circuit. The inductance values of the fixed-values inductors are determined based on the testing of the electronic circuit. As a result, each of the fixed-value inductors will have a second inductance value equivalent to the first value of the corresponding variable inductor. Each of the fixed-value inductors may, in practice, have a second inductance value that is close to but not equal to the first value of the corresponding variable inductor.

FIG. 8H is a process flow diagram (880) showing exemplary steps for designing the prototype electronic circuit comprising one or more capacitors, one or more resistors and one or more inductors. According to the method, a range of capacitance values for at least one of the capacitors in order for the electronic circuit to meet one or more desired operating parameters is estimated (822). According to the method, a range of resistance values for at least one of the resistors in order for the electronic circuit to meet one or more desired operating parameters is also estimated (842). According to the method, a range of inductance values for at least one of the inductors in order for the electronic circuit to meet one or more desired operating parameters is also estimated (862). The estimations of the ranges of the capacitance, resistance and inductance values may, for example, be performed using CAD, simulation and/or modeling. Based on the estimated range of the capacitance values, a variable capacitance range of a variable capacitor that encompasses the range of capacitance values is determined (824). Based on the estimated range of the resistance values, a variable resistance range of a variable resistor that encompasses the range of resistance values is determined (844). Based on the estimated range of the inductance values, a variable inductance range of a variable inductor that encompasses the range of inductance values is determined (864). Consequently, the determined variable capacitance range is used to select (826) a variable capacitor for inclusion in the electronic circuit at the location of the at least one of the capacitors, the determined variable resistance range is used to select (846) a variable resistor for inclusion in the electronic circuit at the location of the at least one of the resistors, and the determined variable inductance range is used to select (866) a variable inductor for inclusion in the electronic circuit at the location of the at least one of the inductors.

The prototype electronic circuit described herein may be configured as a digitally variable network for optimizing one or more parameters of at least one of: an electronic circuit, an electronic device and an acoustic device. Using such a digitally variable network for parameter optimization during a circuit and/or device design process can reduce the number of iterations of design process including one or more of: fabricating the circuit; testing the fabricated circuit; and/or adjusting component value(s) based on the testing and desired parameter value(s).

The usage of the prototype electronic circuit described herein is capable, but not limited to providing a matching network for optimizing and/or compensating one or more parameters of a single electronic circuit. Optionally, the prototype circuit may form a part of an electronic circuit that is configured to be connected to one or more other electronic circuits and/or devices. In such cases, it is possible that some of the parameters of the electronic circuit may change after the electronic circuit is connected to the one or more of the electronic circuits and/or devices. Such changes may be, for example, be due to hardware parasitics originating from one or more of: a die surface, laminate, multi-chip module, and packaging. These may be difficult to precisely predict, and therefore, may sometimes not have been taken into account an initial design and/or simulation. The prototype circuit may be configured to readjust some of the parameters to desired values after such changes.

Furthermore, particularly in RF applications, multiple components may be integrated in a same device or a system. This often leads to multiple components may need to be connected to a common part or a component. However, it is possible that one or more parameters of the common par or component, such as its mode, may not be optimal parameters for all of the connected multiple components. In such cases, determining the parameters of the common part involves a fine trade off, taking into account the resulting performances of the device or system, and/or connected components. Nevertheless, making such a tradeoff is often time-consuming and does not necessarily result in a device with the best achievable performances. To this end, one or more of the prototype circuits may be connected to one or more of such connected components so that the parameters (e.g. acoustic tuning elements) of the connected components may be further adjusted at any time. This obviates the needs for making a tradeoff between performances of multiple components, or enable such a tradeoff to be made more efficiently.

Such ability to adjust parameters at any time may also be useful for rectifying errors at post-production stages. For example, one or more devices are found, after production, not to meet one or more device specifications, one or more of the prototype electronic circuit may be connected to one or more components of the device to determine which value(s) of which component(s) need to be adjusted and the exact value(s) to which the component(s) need to be adjusted, to bring the device specification into compliance. Accordingly, the devices can be returned to a production line for further modification.

FIG. 8I is a process flow diagram showing operations performed by CAD, simulation, and/or modeling software according to certain embodiments.

The process of FIG. 8I can be implemented by the CAD, simulation, and/or modeling software 899 (“software” 899) of FIG. 8J. The software 899 can be stored in memory of the computing system 898 and execute on one or more processors of the computing system 898, and can be configured for designing, simulating, and/or modeling circuitry. For example, the software 899 can include software used to design, simulate, and/or model integrated circuits, multi-chip modules, or other microelectronic components. The software 899 can comprise a single software tool or multiple software tools, such as a CAD tool, a simulation tool, and a modeling tool implemented as separate products, or a single product implementing all of this functionality.

At step 890, the process 890 generates a software model or other representation of the prototype electronic circuit. For example, a user can create the circuit using a graphical user interface (GUI) of the software 899 and the software 899 can generate the software model based on the user created design. The prototype circuit may include any of the circuits described herein, such as the circuits of FIG. 1, 3, 4, 6, 7, 9, 10A-B, 11A-B, 12, or 13, for example.

At step 892, the process runs a simulation using the software model of the prototype circuit to estimate ranges of capacitance, resistance, and/or inductance values, e.g., similar as described herein with respect to FIGS. 8B, 8D, 8F, and/or 8H. For example, step 890 may be performed by a CAD software tool, and step 892 may be performed by a simulation tool, which may be separate from the CAD software tool or integrated together in one product. The user can interact with the software 899 in step 892 to iteratively simulate at different capacitance, resistance, and/or inductance values to determine the estimated ranges, or the tool may automatically execute the simulations according to an algorithm, e.g., based on stored models or based on constraints input by a user.

At step 894, the process determines variable capacitance, resistance, and/or inductance ranges of variable capacitors, resistors, and/or inductors, e.g., as described herein with respect to FIGS. 8B, 8D, 8F, and/or 8H. For example, a user may review results of the simulations, determine the ranges, and input the ranges into the software 899, or the software 899 may determine the ranges based on the estimated ranges generated during the simulation(s).

At step 896, the process outputs a design file for fabricating the prototype circuit. For example, the CAD tool may a design file in a format used by fabrication tools for fabricating the prototype circuit including the variable capacitor(s), resistor(s), and/or inductor(s).

Certain processes described herein describe testing of prototype circuitry, including as steps of FIGS. 8A, 8C, 8E, and 8G. Such testing can be performed using automated test equipment (ATE), such an integrated circuit test handler, or using other appropriate test equipment for analog, mixed signal, or digital test.

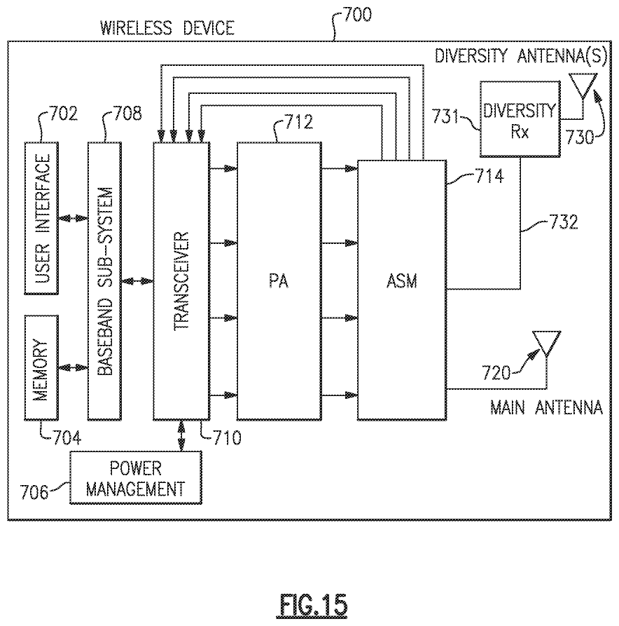

FIG. 14 is a die (610) comprising at least one of the prototype electronic circuits according to the first, second or third aspects of the present invention implemented in a packaged module (620). Such a packaged module can include a packaging substrate (630) configured to receive a plurality of components. In one example, the packaging substrate may be configured to receive one or more switch assemblies having one or more features described herein. In one example the packaged module (620) may be a front end module. In some examples, the packaging substrate (630) may be configured to receive further components such as an RF power amplifier (PA), one or more RF filters, and/or a low noise amplifier (LNA). The packaged module may be implemented in a single-sided or double-sided molded package.

Embodiments of the prototype electronic circuits disclosed herein, optionally packaged into a module, may be advantageously used in a variety of electronic devices. General examples of an electronic device may include a circuit board having numerous modules mounted thereon. The circuit board may have multiple layers and may include circuit elements and interconnections in the layers and/or mounted on the surface of the circuit board. Each of the modules may have a multi-layer substrate within and upon which there may also be various circuit elements and interconnections. Additionally, the modules may further include dies, each of which may have multiple layers and include various circuit elements and interconnections. The prototype electronic circuits disclosed herein may be implemented within, among, or across any of the layers of the various structures, e.g. circuit board, substrates, and dies, as part of an electronic device, such as a smart-phone, wireless tablet, laptop computer, smart device, hand-held wireless device with or without phone functionality, router, cable modem, wireless access point, etc.

FIG. 15 depicts an example wireless device (700) comprising at least one of the prototype electronic circuits according to the first, second and third aspects of the present invention. In the example of FIG. 15, a power amplifier is depicted in a PA module (712); however, it will be understood that such power amplifiers can be implemented in one or more functional blocks, one or more devices such as die or modules, etc. Such power amplifiers can receive their respective RF signals from a transceiver (710) that can be configured and operated to generate RF signals to be amplified and transmitted, and to process received signals. The transceiver (710) is shown to interact with a baseband sub-system (708) that is configured to provide conversion between data and/or voice signals suitable for a user and RF signals suitable for the transceiver (710). The transceiver (710) is also shown to be connected to a power management component (706) that is configured to manage power for the operation of the wireless device (700). Such power management can also control operations of the baseband sub-system (708) and other components of the wireless device (700).

The baseband sub-system (708) is shown to be connected to a user interface (702) to facilitate various input and output of voice and/or data provided to and received from the user. The baseband sub-system (708) can also be connected to a memory (704) that is configured to store data and/or instructions to facilitate the operation of the wireless device, and/or to provide storage of information for the user.

In the example of FIG. 15, an antenna switch module (ASM) (714) can facilitate, for example, multi-band multi-mode operation of the wireless device (700). One or more amplified RF signals may be provided to the ASM (714), and the ASM (714) can route the amplified RF signal(s) to one or more antennas. The PAs (712) can receive corresponding unamplified RF signal(s) from the transceiver (710) that can be configured and operated in known manners.

In the example of FIG. 15, a diversity receive (DRx) module (731) can be implemented between one or more diversity antennas (e.g., diversity antenna (730)) and a front-end module. Such a configuration can allow an RF signal received through the diversity antenna (730) to be processed (in some embodiments, including amplification by an LNA) with little or no loss of and/or little or no addition of noise to the RF signal from the diversity antenna (730). Such processed signal from the DRx module (740) can then be routed to the front-end module through one or more signal paths. In some embodiments, the wireless device (700) may or may not include the foregoing DRx functionality.

In the example of FIG. 15, a plurality of antennas can be configured to, for example, facilitate transmission of RF signals from the PA module (712). In some embodiments, receive operations can also be achieved through some or all of the antennas.

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A method for designing an electronic circuit the method comprising:
providing a prototype electronic circuit comprising one or more capacitors and one or more other components, at least one of the one or more capacitors being a variable capacitor;
testing the electronic circuit by adjusting the capacitance of the one or more variable capacitors to determine one or more first capacitance values of the one or more variable capacitors that cause the electronic circuit to have one or more operating parameters that meet one or more desired operating parameters of the electronic circuit;
determining, based on the testing of the electronic circuit, capacitance values for one or more fixed-value capacitors to replace the one or more variable capacitors in the electronic circuit, each of the fixed-value capacitors having a second capacitance value equivalent to the first value of the corresponding variable capacitor.

2. The method of claim 1 wherein the electronic circuit is an amplifier circuit.

3. The method of claim 1 wherein at least one of the desired operating parameters are defined as one or more fixed values, each of the fixed values having an error margin.

4. The method of claim 1 wherein the capacitance of at least one of the variable capacitors is adjusted to change a shunt capacitance of at least one part of the electronic circuit to cause the electronic circuit to have one or more operating parameters that meet one or more desired operating parameters of the electronic circuit.

5. The method of claim 1 wherein the capacitance of at least one of the variable capacitors is adjusted to change a series capacitance of at least one part of the electronic circuit to cause the electronic circuit to have one or more operating parameters that meet one or more desired operating parameters of the electronic circuit.

6. The method of claim 1 wherein at least one of the operating parameters is dependent on an internal capacitance of at least one component of the electronic circuit.

7. The method of claim 1 wherein at least one of the operating parameters is dependent on at least one parasitic capacitance that exists between two parts of the electronic circuit.

8. The method of claim 1 wherein at least one of the operating parameters is dependent on at least one parasitic capacitance that exists between at least one part of the electronic circuit and an external device or an external component electrically connected to the at least one part of the electronic circuit.

9. The method of claim 1 wherein at least one of the operating parameters is dependent on at least one parasitic capacitance that exists between at least one part of the electronic circuit and a device or a component located adjacent to the at least one part of the electronic circuit.

10. The method of claim 1 wherein the operating parameters include at least one frequency at which at least one part of the electronic circuit oscillates, and the desired operating parameters include at least one desired frequency at which the at least one part of the electronic circuit oscillates.

11. The method of claim 1 wherein at least one of the variable capacitors is configured to function as a decoupling capacitor for decoupling a first part of the electronic circuit from a second part of the electronic circuit.

12. The method of claim 11 wherein the first and second parts of the electronic circuits are coupled through a common impedance to a common power source.

13. The method of claim 1 wherein at least one of the variable capacitors is configured to function as a decoupling capacitor for decoupling at least one part of the electronic circuit and an external device or an external component electrically connected to the at least one part of the electronic circuit.

14. The method of claim 1 wherein at least one of the variable capacitors is configured to function as a bypass capacitor to decouple an AC signal from a first part of the electronic circuit from a second part of the electronic circuit.

15. The method of claim 1 wherein at least one of the variable capacitors is configured to function as a bypass capacitor to decouple a voltage spike and/or a voltage dip from a first part of the electronic circuit from a second part of the electronic circuit.

16. The method of claim 1 wherein at least one of the variable capacitors has a variable capacitance between a first node and a second node, the variable capacitor including:
a switch having a first terminal and a second terminal, an impedance between the first terminal and the second terminal being controllable via a first control node, the switch including two or more transistors;
a first capacitor coupled between the first terminal and the first node; and
a second capacitor coupled between the second terminal and the second node.

17. The method of claim 1 wherein the capacitance of the variable capacitor is adjusted using a controller.

18. The method of claim 1 wherein the controller is configured to automatically adjust the capacitance of the variable capacitor and determine the one or more first capacitance values of the one or more variable capacitors that cause the electronic circuit to have the one or more operating parameters that meet the one or more desired operating parameters of the electronic circuit.

19. A method for designing an electronic circuit the method comprising:
providing a prototype electronic circuit comprising one or more passive components and one or more active components, at least one of the one or more passive components having a variable value;
testing the electronic circuit by adjusting value of the one or more passive components to determine one or more first values of the one or more passive components that cause the electronic circuit to have one or more operating parameters that meet one or more desired operating parameters of the electronic circuit; and
determining, based on the testing of the electronic circuit, values for one or more fixed-value passive components to replace the one or more variable passive components in the electronic circuit, each of the fixed-value passive components having a second value equivalent to the first value of the corresponding variable passive component.

20. The method of claim 19 wherein the one or more fixed-value passive components include one or more capacitors, resistors, or inductors.
